(19) United States
(12) Patent Application Publication
(10) Pub. No.: US 2006/0036394 A1
(43) Pub. Date: Feb. 16, 2006

(54) Universal and integrated wafer testing real-time monitoring software system and its open system architecture

(76) Inventors: Wen-Ling Chen, Taipei City (TW); Ming Wei, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/916,517

(22) Filed: Aug. 12, 2004

(51) Int. Cl. G01M 19/00

(52) U.S. Cl. 702/123

(57) ABSTRACT

A wafer testing real-time monitoring software system and its unique open software architecture which achieves real-time monitoring of wafer test results and on-line changing of externally hooked software to satisfy customer needs without changing its main program. The software structure receives and processes binary files from different probers and converts these into readable ASCII files. The system consists of four software programs that can operate independently. These programs are an automatic transfer program, a program which converts wafer test results from a binary file to an ASCII file, a program which receives the ASCII files and performs wafer map editing, and an auto-ftp program which automatically scans data and sends data to remote locations. Additionally, multiple workstations can process data from probers simultaneously. The on-line monitor on a production line can see production results from multiple major workstations through the network drive and drive mapping functions.

### BACKGROUND OF THE INVENTION

1. Field of the Invention

The present invention relates to testing software. More specifically, the present invention discloses a universal and integrated wafer testing real-time monitoring software system and its open system architecture.

2. Description of the Prior Art

Wafer testing is an extremely important link in the semiconductor industry. However, the testing results need to be analyzed very quickly in order to improve yield. Common programs only provide a database to users from a graphical user interface (GUI). Users cannot find the root cause of low yield wafers from the database because most of them are binary files and show no relationship. Besides, it provides no E test data or ASCII file to users, therefore, it is difficult to trace wafer process errors. Yield improvement is related to wafer manufacturing processes and IC design specifications, but the present invention can perform numerous sorts of analyses to find out the root cause of low yield wafers because all data can be traced under different sub-directories. Data in all different sub-directories of this platform may be data coming from probers, data from testers, data from stdf files, data from E test machines or WAT results from wafer manufacturing processes.

Generally speaking, testers for wafer testing can be of different brands and of different purposes. Major tester vendors include Teradyne, Agilent and Credence. On the other hand, TSK, TEL and EG are also three major brands of wafer probers, which are used in conjunction with testers. Additionally tester terminals may use personal computers (PCs) or workstations, and hence generate PC based or Unix based data files. Binary output files generated by wafer probers are also in different formats depending on brands. Due to marketing considerations, software from one prober vendor does not support reading binary file types of another vendor. So users must buy different supporting software to accommodate different probers and shortcomings and loopholes appear at the system integration level. Furthermore users easily subject themselves to pressure from vendors, such as they should only buy one type of prober. Additionally, they cannot generate good competition among prober vendors and have an active position in accessing technologies.

Wafer testing factories in Taiwan are facing no smaller a challenge than that of foundries. In order to take orders from TSMC or UMC, testing factories must send back results as soon as possible in TSMC or UMC compatible formats. Currently it is even required to send files immediately after testing. At the same time testing factories need to handle data transfer for different IC design companies and this transfer is automatic. When using different probers, reading binary files generated from different probers and converting them into ASCII files is also a challenge because all conversions should be done by a single piece of automation software, not by different programs in different paths. Furthermore users should not perceive any difference despite different data formats.

In the automation software there exists a mechanism that can tell the type of prober generating a file and call corresponding routines to read and convert a file. Moreover, accuracy of test data is also very important. Many testing factories use tester generated software bin files as their basis. But if a part of the dies on a wafer are retested, the second results only contain results of those dies retested, not results from the whole wafer. This requires a manual decision and a program to merge these test results into a file. The number of passing dies after merge and that in the hardware bin file read by a prober may become inconsistent. Normally TSMC or UMC also requires sending back both software bin files (generated by testers) and hardware bin files (generated and converted by probers). This data cannot contain any errors and cannot be changed manually with an editor. If a change is needed, then changed data become the basis due to the exceptions.

Foundries have adequate manpower and resources for system level integration, however, owing to this very advantage, foundries have to spend a lot in manpower to support system integration.

Therefore, there is need for a universal and integrated wafer testing real-time monitoring software system with an open system architecture, which enables data processing with very little manpower and no error, and conveniently and efficiently analyzes production data and tracks yield and yield improvement.

### SUMMARY OF THE INVENTION

To achieve these and other advantages and in order to overcome the disadvantages of the conventional method in accordance with the purpose of the invention as embodied and broadly described herein, the present invention provides a universal and integrated wafer testing real-time monitoring software system and its open system architecture.

The present invention, under the condition of limited manpower support, provides unique automation software to support production and R&D related departments in an effective and cost-saving manner. Furthermore, issues arising from production lines, due to personnel changes or caused by new workers unfamiliar with operation of software, or data which contains errors and cannot be send out, are eliminated. This invention has a mechanism that not only provides all backup and logging functionalities but most importantly uses files to complete all workflows required by different devices. These workflow files can be modified and maintained very easily. Most importantly, these file are managed by dedicated staff. To production line operators, operating this software involves no menu selection. It only requires clicking a few buttons to go to a particular wafer from a particular lot to generate all data. Therefore this pushes the foolproof mechanism to a limit and at the same time does not affect making menus during engineering development. Because of this, this invention provides software that is very easy to use. For example, it only takes a single ten-minute training session for operators to become skilful and not error prone.

Other common software on the market cannot provide this function, because they have different architectures than the present invention. Databases of common software are usually stored in locations unknown to users and it is necessary to execute such software in order to see data from different lots. This invention uses a known sub-directory hierarchy; inside the software users can switch freely. Furthermore, the data processing speed of this invention is more than five times of that of typical software on the market.

All results produced by this invention are placed under a fixed path. Therefore anyone can easily locate a file under that fixed path regardless of the file type. It isn't required to operate the software in order to locate data. On the contrary, any text editor can open any data file after the file has been generated in real-time by this invention. Wafer map files consist of both text and graphics files. The graphics files can be opened and edited with a wafer map editor alone. This invention is a system formed by a network of four mutually support programs. Therefore, under normal operating conditions of the first receiving and sending program, the other three programs can all perform any upgrade without affecting data transfer in production lines and without data loss since after the upgrade the automatic data transfer program can re-send data not yet transferred to the network drives according to its built-in intelligence.

The present invention provides a system level mechanism targeting all sorts of possible issues, and this mechanism can solve all imaginable problems. This ultimately leads to a road to success for the semiconductor testing industry. It not only puts users on the same track as the rest of the world but also frees them from the nightmare of being controlled by others.

For other software on the market, an upgrade requires a complete production line shut down and production can resume only after the upgrade has been completed. Because of this, loss of data and retesting in production create great disturbances. Many times carelessness not only makes it necessary to retest wafers but also increases number of returns from customers since dies are deemed defective owing to additional probe marks caused by retesting.

An objective of the present invention is to provide a universal and integrated real-time processing system for wafer testing data, enabling data processing with very little manpower and no error. This system provides a very convenient and efficient analysis platform for research with high stability and simultaneity of production data and subsequent yield tracking and yield improvement.

Another objective of the present invention is to improve the fixed architecture of common software, and to adopt an open architecture. In using the software platform of this invention, when entering, using and exiting this software, users are empowered to create interface files for communication with external software (specified in information files) to achieve communication of this software with external systems through reading data files in the current working directory provided by this software using an external communication interface specification file. Therefore all special requests can be accommodated using this framework without any need of modifying the main program. As a result, errors can be avoided and the labor cost of frequently modifying the main program can be eliminated.

Another objective of the present invention is to provide a dynamic binning change by using associated external programs to extract datalogs from stdf files and change limits based on statistical process control (SPC) analysis and recreate its binning file. This is accomplished based on the flexible architecture which is completely different from other common software. The newly recreated binning file could rescue a lot of marginal dices and improve wafer yield, however, every minor change could be easily monitored under each wafer lot.

Another objective of the present invention is to also add many foolproof mechanisms in addition to providing easy operation and speed in high efficiency. Setting up and locking of operating parameters in an information file makes operators less error prone and preserves flexibility for line management to modify the set-up file. It can completely meet special requirements without having to change the main program.

Another objective of the present invention is to remedy the serious flaw of being able to process data of only one specific prober in common programs, and to provide a framework for data from three major probers on the market, as well as data from a user defined prober. This allows data from any future probers manufactured to be processed using a special definition. This means that all intellectual property rights are held by the software owner instead of being controlled by prober manufacturers.

This invention provides a wafer testing real-time monitoring software system and its unique open software architecture achieves real-time monitoring of wafer test results and on-line changing of externally hooked software to satisfy special needs of customers without changing its main program. The software structure of the present invention can receive and process binary files from different probers and convert these into readable ASCII files. This invention basically consists of four software programs that can operate independently.

The first program is an automatic transfer program, whose basic function is to receive from the production line, binary files or ASCII files in either PC format or Unix format. According to a user defined information file, the program scans for incoming files and then sends out to paths specified in the information file using a network drive function.

The second program converts wafer test results from a binary file to an ASCII file, and has a universal on-line monitoring interface that shows test results in real-time on on-line monitors in production lines through its network drive and drive mapping functions.

The third program receives ASCII files from the second program and performs wafer map editing. Users can call up this editor in different workstations for such wafer map editing. An imperfect or contaminated die can be marked by clicking the mouse pointer over the die. Even if the die tested okay previously, it has to be removed like a bad die. The die data are then saved into a file, which is used to generate off-line inking or an inkless file. All related files are sent out after that. This software also allows mouse click input from users. Alternatively, it also allows machine generated data files about wafer surface imperfection and contamination to be integrated with raw test data file by external software in the postprocessor and the resultant test data to be used instead of mouse clicking input. After all editing is done, the program sends all files to the workstation running the fourth program. The software uses an output trigger file and an error trigger file generated by external software in the post processor as a final gatekeeper to decide whether to send files to the fourth software or not. This is a flexible interface of this invention, and can handle requirements for different products and customers. Because external software is defined in information files according to each individual product, it is not necessary to change the main program to handle any new requirements; all it takes is writing new external software. Inside this program, there are 4 different wafer maps binning selections. All these binning files not only provide a cross check for hardware binning, software binning, stdf binning and process binning but also provide a platform for user to extract data from stdf data log files and create dynamic limits and then recreate a new binning file to rescue some marginal fail die after statistical analysis is made. By doing this, users can improve the yield if process data drifts from lot to lot but still maintain the control of the quality of test while everything is under user's control from remote terminal service. This unique flexibility can let design houses control everything and save a lot of cost.

The fourth program is an auto-ftp program, which automatically scans data and sends data to remote locations. This software is easy to set-up, easy to edit, and provides automatic debugging and convenient to use functions. It also provides a “backup file” function after sending out files. If it is unable to transmit a file, it generates an error message log file so that a user can easily see reasons for any errors and find corresponding solutions. Individual batch files can be set up to target major customers. Using information files set-up by the user, the program can transfer different files related to different products to different subdirectories of different ftp sites according to customer requests. This program provides text file functions for the above-mentioned files. Therefore transition between workers in adjacent shifts is easier and less prone to error. Processing of emergency files is also quicker.

These four programs can work independently. However, owing to their mutual support functions, they can form a seamless network to handle requests both from production lines and from customers. Moreover, the second and the third program can call pre-processor, post-processor and user procedures. Therefore no frequent modification to this open software architecture is required once it is completed. Any special requirement can be met by modifying external software. External software exists in batch files for pre-processor, post-processor and user procedures.

In addition, this invention processes a universal integration function which can process files from different types of probers like TSK, TEL and EG. The unique design of this invention enables it to process files in these three different formats generated by the above probers in a uniform manner. After processing, the result is in a standardized ASCII format and the editing program can further process it. To meet requirements from different customers, final output files can be made into different device dependent formats by using external software to facilitate sending out of the file.

Another major characteristic of this invention is that multiple workstations can process data from probers simultaneously. The on-line monitor on a production line can see production results from multiple major workstations through the network drive and drive mapping functions. After which it can take the next processing step, which is to re-generate a raw data floppy diskette depending on whether a retest or a fail die retest is necessary. This greatly reduces cycle time of wafer testing. This invention also has a multi-processing function. As a result it can minimize risks of data loss. It also has a built-in intelligence function, so upgrading of any of the four programs does not affect data communication between them.

To summarize, this invention aims at improving production line monitoring efficiency during wafer testing, minimizing problems during upgrade of data processing automation software and improving efficiency in handling of abnormalities. As a result, it greatly smoothes the work flow. The open software architecture makes it possible for all R & D and production departments to create different external programs to suit their needs. After a supervisor includes these into the device definition file, the programs can process data following instructions in this file. In addition, this file can also disable any menu items in the editor program and prevent operators from choosing the disabled item thereby make production lines foolproof.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a data processing flow chart showing interaction between the four programs in this invention;

FIG. 2 is an operational flow chart of the internal data transfer software, the first software of this invention called autoxfer.exe;

FIG. 3 is an operational flow chart of the automatic processing software, the second software of this invention called autoprocess.exe;

FIG. 4 is an operational flow chart of the wafer map editing software, the third software of this invention called editor.exe;

FIG. 5 is an operational flow chart of the external data transferring software, the fourth software of this invention called winftp.exe;

FIG. 6 is a screenshot during execution of autoxfer.exe;

FIG. 7-1 is listing of AUTO.BAT, a batch file used during execution of autoxfer.exe;

FIG. 7-2 is a listing of IOINFO.TXT, an input and output information file used during execution of autoxfer.exe;

FIG. 7-3 is a listing of DEVLOOKUP.TXT, a file used during execution of autoxfer.exe;

FIG. 8 is a listing of PROCESS.BAT, a batch file used during execution of autoprocess.exe;

FIG. 9-1 is a screenshot of the first screen after autoprocess.exe starts;

FIG. 9-2 is a screenshot showing after autoprocess.exe starts, the pull-down menu under the “Action” option;

FIG. 9-3 is a screenshot showing after autoprocess.exe starts, the pull-down menu under the “Tools” option;

FIG. 10 is a screenshot showing after the “Retest device” item under the “Action” option is chosen where selection of devices is made by mouse cursor;

FIG. 11 is a screenshot following FIG. 10, whereby selection of probe is made by the use of the mouse cursor;

FIG. 12 is a screenshot following FIG. 11 and shows selection of the lot number of a wafer;

FIG. 13-1 is a screenshot following FIG. 12 and shows basic information about the lot which includes yield, start of testing and end of testing;

FIG. 13-2 is a screenshot for selecting the “To Floppy” button in the right bottom of screen after selecting the wafer on the right with the mouse cursor;

FIG. 13-3 is a screenshot for selecting “Run TSK2tsmc” button in the left bottom of screen after selecting wafer of the left with the mouse cursor;

FIG. 13-4 is a screenshot after selecting “View lot” under “Action”;

FIGS. 13-5 and 13-6 are screenshots after selecting “View Wafers Statistics” under “Action”;

FIG. 13-7 is a screenshot after selecting “Find Lot/Prober” under “Action”;

FIG. 13-8 is a screenshot following FIG. 13-7;

FIG. 13-9 is a screenshot after selecting “Run Editor” under “Action”;

FIG. 14-1 is a screenshot after that in FIG. 13-9;

FIG. 14-2 is a screenshot after that in FIG. 14-1;

FIG. 14-3 is a screenshot after that in FIG. 14-2, after entering editor and selecting “File”;

FIG. 14-4 is a screenshot after that in FIG. 14-3, after selecting “Select Wafer/Lot” in “File”;

FIG. 14-5 is a screenshot after that in FIG. 14-4 and the wafer map screen, and now it enters editor.exe;

FIG. 15-1 is a screenshot after selecting “Transfer Lot Date . . . ” under “Action”;

FIG. 15-2 is a screenshot after that in FIG. 15-1;

FIG. 15-3 is a screenshot after that in FIG. 15-2;

FIG. 15-4 is a screenshot which displays the running of waftermap.exe after selecting “wafers” under “mouse, shift key, control key” and FIG. 15-3;

FIG. 15-5 is a screenshot after that in FIG. 15-4 which shows automatic invoked KEDIT program to show the WPR (wafer Probe Record) file;

FIG. 16-1 is a screenshot after that in FIG. 15-5, and after selecting Transfer Lot Data . . . under editor.exe file;

FIG. 16-2 is a screenshot after that in FIG. 16-1, showing options under transfer data;

FIG. 16-3 is a screenshot after that in FIG. 16-2;

FIG. 16-4 is a screenshot after that in FIG. 16-3, showing wafer selection;

FIG. 16-5 is a screenshot after that in FIG. 16-4, showing data file under the process of wafermap.exe;

FIG. 16-6 is a screenshot after that in FIG. 16-5, showing the automatic calling of KEDIT program to display the WPR (wafer Probe Record) file;

FIG. 17-1 is a screenshot after selecting “INK” under the “Edit” option in editor.exe;

FIG. 17-2 is a screenshot after that in FIG. 17-1, showing mouse selection of four contaminated dies;

FIG. 17-3 is a screenshot after selecting “Inkless File Output” under the “Edit” option in editor.exe;

FIG. 17-4 is a screenshot after selecting “Display Options” under the “Edit” option in editor.exe;

FIG. 17-5 is a screenshot showing third quadrant of die after 4 partitions is selected and mouse click on third quadrant on small display of wafer;

FIG. 17-6 is a screenshot showing one partition of 16 partitions after 16 partitions is selection and mouse click on one of the 16 partitions;

FIG. 17-7 is a screenshot of another one of partition of 16 partitions;

FIG. 17-8 is a screenshot showing the pull down menu of view;

FIG. 17-9 is a screenshot showing site 5 is selected after “Show Site List” is selected first;

FIG. 17-10 is a screenshot showing 3 different sub-windows once 3 selections are selected;

FIG. 17-11 is a screenshot showing the pull down menu of “Edit” main menu;

FIG. 17-12 is a screenshot showing the sub-window when “Edit Overlay” is selected;

FIG. 17-13 is a screenshot showing the whole lot overlay wafer mapping after “Edit Overlay” and “Select Wafer/Lot Info” are selected sequentially; therefore, each die data represents the percentage of pass die in the whole lot in this particular die location;

FIG. 18-1 is a screenshot after selecting “Launch User Procedure” under the “Tools” option in editor.exe;

FIG. 18-2 is a screenshot after that in FIG. 18-1, showing selection of user procedures by mouse on screen;

FIG. 18-3 is a screenshot after selecting “View Hardbin Lot Info” under the “Tools” option in editor.exe;

FIG. 18-4 is a screenshot after selecting “Edit Hardbin Lot Info” under the “Tools” option in editor.exe;

FIG. 18-5 is a screenshot after selecting “View Softbin Lot Info” under the “Tools” option in editor.exe;

FIG. 18-6 is a screenshot after selecting “Edit Softbin Lot Info” under the “Tools” option in editor.exe;

FIG. 18-7 is a screenshot after selecting “Compare Softbin and Hardbin” under the “Tools” option in editor.exe;

FIG. 19-1 is a listing of the Batch file used by winftp.exe, the fourth software of this invention;

FIG. 19-2 is a listing of ioinfo.txt, input and output information file used by winftp.exe, the fourth software of this invention;

FIG. 19-3 is a screenshot during execution of the fourth software winftp.exe;

FIG. 20 is a screenshot when a prober test and prober vendor look-up table is being set up in prober_text.txt of this invention;

FIG. 21-1 and 21-2 are a listing of defdev.inf of this invention. Autoprocess.exe and editor.exe must read files of this name in different directories and lock menu options based on set up for different products and relevant key words in the files;

FIG. 22 is a drawing illustrating a directory structure according to an embodiment of the present invention; and

FIG. 23 is a drawing illustrating a directory structure according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

Regarding this invention, all detailed explanations on the software specification are described in the following software description of functionality and capability.

Conventions:

This documentation uses the following typographic conventions:

| | |
|---|---|
| Example | Description |

| | |
|---|---|
| [option] | Items inside single square brackets are optional. |
| {1\|2} | Braces and a vertical bar indicate a choice among |
| | two or more items. You must choose one and |
| | only one of these items. |
| [option . . .] | Three dots (an ellipsis) following an item indicate |
| | that more items having the same form may appear. |
| EdaData | Bold type indicates keyword or word that must |
| | be spelled exactly as shown except the case, |
| | which is insensitive. |
| netdrive | Words in italics indicate placeholders such as |
| lotNo or | file name or directory. |
| Autoprocess.exe | All file names, directories and/or programs (.exe) |
| | are case insensitive. |

Functionality:

Autoprocess.exe (Win32 program)

Description: periodically scans through all subdirectories under a source directory and automatically processes any existing TSK format binary wafer file based on a given lookup table. It calls tsk2tsmc.exe for each binary wafer file to produce TSMC format ASCII wafer file and other files for later use by editor.exe. The following is the list of output files that tsk2tsmc.exe produces and their naming convention:
mark0001.txt, i.e., “dstMarkFile” in the description of tsk2tsmc.exe
map_{—}0001.txt, i.e., “dstWaferMapt” in the description of tsk2tsmc.exe
dstTsmcAsciiFile, i.e., “dstTsmcAsciiFile” in the description of tsk2tsmc.exe
dstTsmcAsciiFile.log, i.e., “dstTsmcAsciiFile.log” in the description of tsk2tsmc.exe
map.inf
map._lhs.inf
test.txt
test_lhs.txt

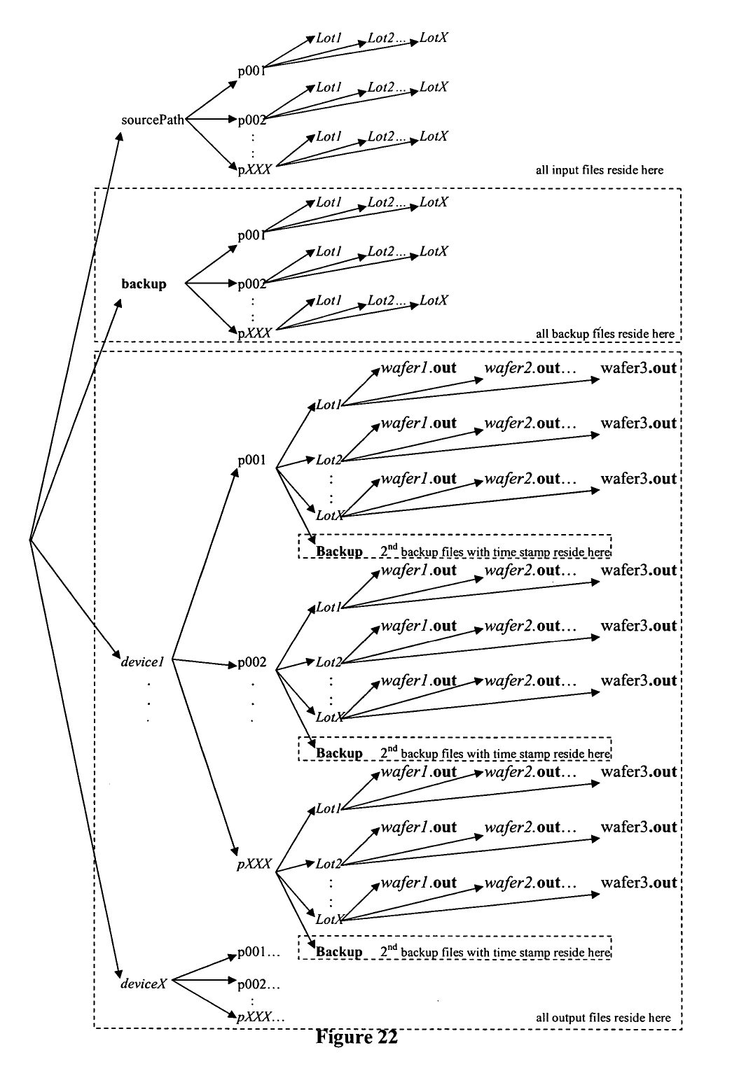

Please refer to the description of tsk2tsmc.exe for more detail on these output files. All processed files are moved to a backup directory. It assumes the directory structure as shown if FIG. 22.

It is run in minimized mode since there is no need to interface with the user.
Usage: autoprnt [-d] [−fNetdrive.lst]-linflookup.txt-Ittellookup.txt-lootherlookup.txt [-n] [-sSrcPath] [-r7] [-t30] [-w]

Example: autoprnt -t1 -w -d -sd:\monitor \map -fnetdrive.txt -linflookup.txt- Ittellookup.txt -lootherlookup.txt

Example: x:\monitor \map\autoprnt -t0.5 -n -d -sx:\monitor \map -fx:\monitor \map\netdrive.lst

-lx:\monitor \map\inflookup.txt-Itx:\monitor\map\tellookup.txt - lox:\monitor\map\otherlookup.txt

Note: the drive specified in x:\monitor\map\netdrive.lst is relative to current machine (the machine that starts autoprnt), not x drive (the machine where autoprnt resides.) So, if x:\monitor\map\netdrive.lst specifies ‘c’, it refers to c drive for current machine.

Arguments: All arguments' order is insignificant.

-d

Disables printing all output text files to printer. This argument is optional. Default is print all files, if not specified.

-fNetdrive.lst

Specifies the network drive list in a file named Netdrive.lst. This file must be an ASCII text file that contains only one network drive letter (case insensitive) in each line. Any line starts with ‘;’ is a comment line and is ignored by the program. If this argument is specified, all output text files will be duplicated to the corresponding directory in network drives as well as to \tsmc\EdaData\device\lotNo in all network drives. This argument is optional.

Example of the network drive list file which specifies five network drives, H, X, Y and Z will look like this:
H
;M This is a comment line and will be ignored by the program
X
Y
Z

-linflookup.txt

Specifies the lookup table of directory and wafer data options for each lot of wafers in a file named Netdrive.lst. The file name can be either full name (including full path) or partial file name. This file must be an ASCII text file that contains lines in the following format:

| | Field1 | Field2 | Field3 | Field4 | Field5 | Field6 |
|---|---|---|---|---|---|---|
| Line1 | Device_Name | Output_device_dir | {-b0\|-b1} | {-sort1\|-sort2} | {[TSMC]\| | [Text_to_update_map.inf] |
| | | | | | IBM\|UMC} | |
| Line2 | ″ | ″ | ″ | ″ | {[TSMC]\| | ″ |
| | | | | | IBM\|UMC} | |
| . | | | | | | . |
| . | | | | | | . |
| . | | | | | | . |
| LineN | ″ | ″ | ″ | ″ | {[TSMC]\| | ″ |
| | | | | | IBM\|UMC} | |

Field1: the device name string contained in each TSK format binary wafer file. This is the key to look up.
Field2: specify the output device directory under source directory.
Field3: specify if bin 0 is valid for this device. Use -b0 if allow bin 0; otherwise use -b1.
Field4: specify if the wafer data is sort1 or sort2 data. Use -sort1 for sort 1, -sort2 for sort 2.
Field5: specify the wafer data in TSMC, IBM or UMC format. This field is optional provided that field6 is omitted. Default is TSMC format, if not specified.
Field6: specify any update string(s) to overwrite the one(s) in map.inf. This provides a way of fixing the wafer data produced by TSK prober. All text pass field5 is considered field6. This field is optional.

The first field starts at the first character of the line. Each field is separated by either blank(s) or tab. There is no limit on number of lines in this file. However, it's limited to the amount of available memory. The default inflookup.txt table are for TSK prober.

-Ittellookup.txt

Once tellookup.txt is specified, Autoprocess.exe load tellookup.txt table and call tel2tsmc.exe if this file comes from the TEL prober which is specified in prober_tester.txt file.

-lootherlookup.txt

Once otherlookup.txt is specified, Autoprocess.exe load tellookup.txt table and call other2tsmc.exe if this file comes from the OTHER prober which is specified in prober_tester.txt file.

-n

This argument is optional and is only used by tsk2tsmc.exe. Please refer to the “-n” argument in the description of tsk2tsmc.exe for more detail.

-sSrcPath

Specifies the source directory. This path can be either full path or partial path. This argument is optional. Default is \monitor \map in current drive.

-r7

Specifies in days how frequent to delete empty subdirectories under the source directory. The number following “-r” must be an integer number. This argument is optional. Default is 7 days, if not specified.

-t30

Specifies in minutes how frequent to scan subdirectories under the source directory. The number following “-t” can be either an integer or a floating point number. This argument is optional. Default is 30 minutes, if not specified.

-w

This argument is optional and is only used by tsk2tsmc.exe. Please refer to the “-w” argument in the description of tsk2tsmc.exe for more detail.

Tsk2Tsmc.exe (DOS program)

Description: converts TSK format binary wafer file into TSMC format ASCII wafer file and produces all files that are needed for running editor.exe for that wafer. The following is the complete list of the output files:
dstMarkFile, marking dice and skip dice list for this wafer. This is an ASCII file.
dstWaferMap, wafer map diagram for this wafer. This is an ASCII file.
DstTsmcAsciiFile, TSMC format ASCII wafer file in left-hand system.
dstTsmcAsciiFile.log, TSMC format ASCII wafer file in original hand system.
map.inf, wafer map info file for original hand system. This is an ASCII file.
map_lhs.inf, wafer map info file for left-hand system. This is an ASCII file.
test.txt, row spans definition for this wafer for original hand system. This defines all valid dice (good and bad dices, not including marking or skip dice) for this wafer. This is an ASCII file.
test_lhs.txt, row spans definition for this wafer for left-hand system. This is an ASCII file.
Usage: tsk2tsmc [{-b0|-b1}] [{-cIBM\KcUMC}]-ic:\monitor\map\device_bin.inf [-n] [−pPXXX] [-sortN] [-uUpdateStr] [-w] srcTskBinaryFile dstMarkFile dstWaferMap dstTsmcAsciiFile.log

Example: tsk2tsmc -b1 -sort1 -w -pP001 -ic:\monitor \map\C952bin.inf c:\monitor
\map\p099\fa8006.1\001.FA8006-01B6 c:\monitor
\005\p099\fa8006.1 \001.FA8006-01B6.out\mark0001.txt c:\monitor
\005\p099\fa8006.1\001.FA8006-01B6.out\map_{—}0001.txt c:\monitor
\005\p099\fa8006.1\001.FA8006-01B6.out\map_{—}0001.log
   Arguments: All optional arguments' order is insignificant and all required arguments' order is significant.

-b0, -b1

Specifies if bin 0 is valid for this wafer. Use -b0 if allow bin 0; otherwise use -b1. This argument is optional. Default is -b1, if not specified.

-cIBM, -cUMC

Specifies the wafer data and the I/O file naming convention is TSMC, IBM or UMC format. This argument is optional. Default is -cTSMC, if not specified.

-ic: \monitor\map\device_bin.inf

Specifies the bin info file for this wafer. The file name can be either full name or partial name. This file must be an ASCII file and must contain at least one line for each of the following formats except “password:” line is optional.

| Keyword | Field1 | Field2 |
|---|---|---|
| pass—bin: | {0\|1\| . . . \|9} | {0\|1\| . . . \|63\|64} |
| downgrade—bin: | {0\|1\| . . . \|9} | {0\|1\| . . . \|63\|64} |
| bin—code: | {A\|B\| . . . \|Z\|a\|b\| . . . \|z\|0\|1\| . . . \|9} | {0\|1\| . . . \|63\|64} |
| product—name: | product_name | |
| product—code: | product_code | |
| tester—id: | tester_ID | |
| test—program: | test_program | |
| probe—card—id: | probe_card_ID | |
| load—board—id: | load_board_ID | |
| bin—definition: | bin_definition | |
| password: | password | |

pass_bin: followed by 1 letter and 1 number to specify a pass bin. The letter is the ASCII representation of this bin and it can be any letter from A-Z, a-z or 0-9. The number is the bin code and it can be any number from 0-63 if allow bin 0, or 1-64 if not allow bin 0. Theoretically, you can specify as many pass bins up to 64.
downgrade_bin: same as “pass_bin:” line except that it specify a downgrade bin.
bin_code: same as “pass_bin:” line except that it specify a fail bin.
product_name: followed by any text string up to 7 characters. This defines the product name to be shown in the header line of the output TSMC format ASCII wafer file.
product_code: followed by any text string up to 6 characters. This defines the product code to be shown in the header line of the output TSMC format ASCII wafer file.
tester_id: followed by any text string up to 8 characters. This defines the tester ID to be shown in the header line of the output TSMC format ASCII wafer file.
test_program: followed by any text string up to 30 characters. This defines the test program to be shown in the header line of the output TSMC format ASCII wafer file.
probe_card_id: followed by any text string up to 12 characters. This defines the probe code ID to be shown in the header line of the output TSMC format ASCII wafer file.
load_board_id: followed by any text string up to 12 characters. This defines the load board ID to be shown in the header line of the output TSMC format ASCII wafer file.
bin_definition: followed by any text string up to 20 characters. This defines the bin definition to be shown in the header line of the output TSMC format ASCII wafer file.
password: followed by any text string up to 127 characters. This defines the password to be shown in output map.inf file. Please refer to the description of editor.exe for more detail. This line is optional.

The keyword and each field are separated by either blank(s) or tab.

-n

Output short form instead of long form for map diagram file and marking dice and skip dice list file. This argument is optional. Default is long form, if not specified.

-pPXXX

Specifies the prober number for the input wafer file. It must be in the range of p001 to p999.

-sortN

Specifies the sort number for the input wafer file. It must be in the range of sort1 to sort9.

-uUpdateStr

Specifies the update text to replace the counter parts in the bin info file (defined in “−i” argument.) Please refer to “Field6” for the “-1” argument in the description of Autoprocess.exe for more detail.

-w

Specifies if tsk2tsmc.exe should pause the DOS window and wait for a key stroke before it exits. This allows the user to view any message (either success or error) that tsk2tsmc.exe shows. This argument is optional. Default is no pause, if not specified.

srcTskBinaryFile

Specifies the input TSK format binary wafer file. This file name can be full name or partial name.

dstMarkFile

Specifies the output file for marking die and skip die list. This file name can be full name or partial name.

dstWaferMap

Specifies the output file for the wafer map diagram. This file name can be full name or partial name.

dstTsmcAsciiFile.log

Specifies the output TSMC format ASCII wafer file. This file name can be full name or partial name.

Tel2Tsmc.exe (DOS program)

Description: converts TEL format binary wafer file into TSMC format ASCII wafer file and produces all files that are needed for running editor.exe for that wafer. The usage method is the same as Tsk2Tsmc.exe program

Eg2Tsmc.exe (DOS program)

Description: converts EG format binary wafer file into TSMC format ASCII wafer file and produces all files that are needed for running editor.exe for that wafer. The usage method is the same as Tsk2Tsmc.exe program.

Other2Tsmc.exe (DOS program)

Description: converts OTHER format binary wafer file into TSMC format ASCII wafer file and produces all files that are needed for running editor.exe for that wafer. Other format means any brand name prober which is not in the main stream. The usage method is the same as Tsk2Tsmc.exe program

Wafermap.exe (DOS program)

Description: converts TSMC format ASCII wafer file into TSK format binary wafer file. It also produces map.idx and other report files. The following is the list of all output files and their naming convention:
slotNo.waferID, slotNo is a 3-digit number. This is the TSK format binary wafer file.
srcTsmcAsciiFile.RPT, if “-f” argument is specified. or MAP_nnnn.RPT, if “-f” argument is not specified. nnnn is a 4-digit number. This is the report file for the wafer.
lot.RPT, the grand report for the entire lot.
MAP.IDX, TSK format binary map index file.
. . . \dstDir\lot.final.csv, the Excel format final statistics file for the entire lot.
srcDir\inldess\lot.lis, if “{-kSPILOLD|-kSPILNEW|-kSPLIOPT}” argument is specified, the report file for SPIL inkless output for the lot.
srcDir\inldess\waferID.map, if “{-kSPILOLD|-kSPILNEW|-kSPLIOPT}” argument is specified, the SPIL format inkless file for the wafer.
srcDir\inkess\deviceName, if “{-kSPILOLD|-kSPILNEW|-kSPLIOPT}” argument is specified, the layout file for SPIL inkless output for the device.
srcDir\inkless\LotWaferNo.CompanyCode, if “-kASE” argument is specified. WaferNo is a 2-digit number. CompanyCode is a 2-character company name abbreviation. This is the inkless file for the wafer.
srcDir\inkless\deviceName.lay, if “-kASE” argument is specified. This is the layout file for this device.
srcDir\inkless\deviceName.anm, if “-kANM” argument is specified, the ANIM format inkless file for this wafer.
Usage: wafermap [-2floppy] [{-b0|-b1}] [{-cIBM|-cUMC}] [-f] [{-kANM|−

kSPILOLD|-kSPILNEW|-kSPLIOPT|-kASE}] [-nDevName] [-softbin] [-s] [−xsuffix] [{-ymin2ymax\kymax2ymin}] map.inf srcTsmcAsciiFile dstPath

Example: wafermap -f -x -F -kASE -nmv4300 -s -b1
D:\tsmc\EDAdata\4300\g 10066.1\map.inf
D:\tsmc\EDAdata\4300\g 10066.1\G10066.1-1-03-F
D:\tsmc\EDAdata\4300\g10066.1\G10066.1
   Arguments: All optional arguments' order is insignificant. All required arguments' order is significant and must be specified after all optional arguments.

-2floppy

Tells wafermap.exe to also output the TSK format binary file using floppy file convention and map.idx to a:\map directory on a floppy drive. This argument is optional.

-b0, -b1

Specifies if bin 0 is valid for this wafer. Use -b0 if allow bin 0; otherwise use -b1. This argument is optional. Default is -b1, if not specified.

-cIBM, -cUMC

Specifies the wafer data is TSMC, IBM or UMC format. This argument is optional. Default is

-cTSMC, if not specified.

-f

Forces the report file name for each wafer the same as the input wafer file name, but with “.rpt” extension, instead of using floppy output file name convention. This argument is optional. Default is using floppy output file name convention for individual report file, if not specified.

-kANM, -kSPILOLD, -kSPILNEW, -kSPLIOPT, -kASE

Tells wafermap.exe to also output the specified format inkless file. “-kSPILOLD” and “-kSPILNEW” are obsolete and should not be used any more. They are here for backward compatibility. This argument is optional. Default is no inkless file output, if not specified.

-nDevName

Specifies the device name string to be shown when output the inkless file. This argument is only required if inkless output file is specified.

-softbin

Tells wafermap.exe that the bin codes in input wafer file are software bin codes instead of hardware bin code. This argument is optional. Default is hardware bin codes, if not specified.

-s

Specifies the input wafer file is sampling sort. This argument is optional. Default is not sampling sort, if not specified.

-xsuffix

Specifies the suffix of the input TSMC format ASCII wafer file name. This argument is optional. Default is “-F”, if not specified.

-ymin2ymax, -ymax2ymin

Forces the y order of dice when outputting TSK format binary wafer file. This argument is optional. Default is using original order defined by line “y_dir:” in map info file, if not specified.

map.inf

Specifies the input map info file. This file name can be full name or partial name.

srcTsmcAsciiFile

Specifies the input TSMC format ASCII wafer file. This file name can be full name or partial name.

DstPath

Specifies the output directory. This path can be full path or partial path.

Editor.exe (Win32 program)

Description: provides a GUI to let the user view, edit, save and transfer wafer data, statistics and report files.

For supervisor only:

An external file user.txt in the info directory (see below directory structure) defines a list of users along with their levels of authority to run editor.exe. The least authority can only view and transfer wafer data, but cannot edit or save the wafer data. The highest authority can also edit dice, change notch, change the pass bin code, unlock the data for editing and save the changes. This file contains lines in the following format:

| User_Name | Password | EditTypes | Unlock |
|---|---|---|---|
| user_name1 | Password1 | [{IQC\|CP1\|CP2\|INK\| | [unlock] |
| | | V/M\|P-S L/A} . . . ] | |
| user_name2 | Password2 | [{IQC\|CP1\|CP2\|INK\| | [unlock] |
| | | V/M\|P-S L/A} . . . ] | |
| . | | | |
| . | | | |
| . | | | |
| user_nameN | PasswordN | [{IQC\|CP1\|CP2\|INK\| | [unlock] |
| | | V/M\|P-S L/A} . . . ] | |

User_Name field, up to 10 characters, case insensitive.

Password field, up to 10 characters, case sensitive.

EditTypes fields, specifies the editing power for that user. Up to 6 fields can be specified, all case insensitive and can be in any order.

Unlock field, specifies if that user has the power of unlocking the data. This field is case insensitive.

A line starts with ‘;’ is a comment line and is ignored by the program.

All required fields must be specified in the above order. All optional fields can be specified in any order, but must be appeared after all required fields. The first field starts at the first character of the line.

This file should only be created and edited by the person with the highest authority to run this program, and be made as a hidden file. The following is an example of the file contents of user.txt:
; Line syntax: UserName Password EditType1 EditType2 . . . EditTypeS
;
; UserName: up to 10 characters, case insensitive, must be the 1st field.
; Password: up to 10 characters, case sensitive, must be the 2nd field.
; EditTypeN and unlock: all case insensitive, must be the 3rd and up fields,
; but can be in any order.
Nancy grandma IQC CPI
JoJo child CPI IQC INK V/M P-S_L/A
Robert pswd1 unlockP-S_L/AINK
u234567890edf p234567890abc CPI
Chu hoho INK
007 007 INK CP1 CP2 IQC V/M P-S_L/A unlock

An external file company.inf in the info directory (see below directory structure) defines a list of company names along with their 2-character abbreviation. The file contains lines in the following format:

| Company_Abbreviation | Company_Name |
|---|---|
| Company_abbr1 | Company1 |
| Company_abbr2 | Company2 |
| . | . |
| . | . |
| . | . |
| Company_abbrN | CompanyN |

Company_Abbreviation field, 2-character string, specifies the abbreviation for that company.

Company_Name field, a text string, specifies the company's name.

All fields' order is significant. The first field starts at the first character of the line.

The following is an example of the file contents of company.inf:
TM TSMC
RM QED
LA LARA
OP OPTI
OA OASIS
ES ESST
UM UMC
MA MARVELL
MV MARVELL
TR TRIDENT

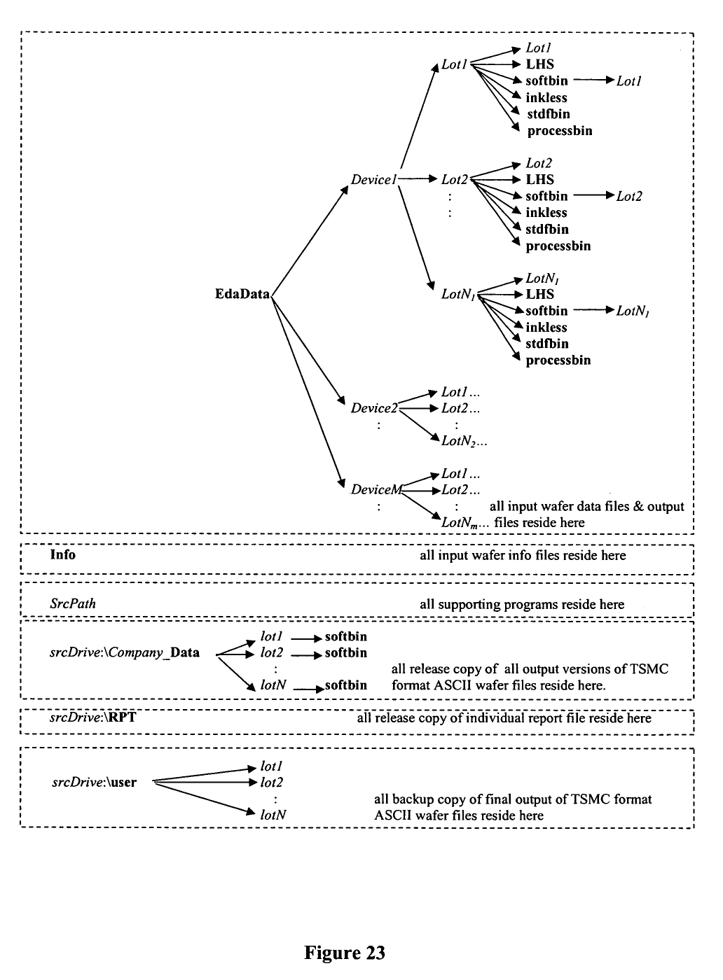

The program assumes directory structure, for source TSMC format ASCII wafer files, source info files, supporting programs and output files, as shown in FIG. 23.
Usage: editor [-sSrcPath]
   Example: editor -sd:\tsmc\program
      Arguments:

-sSrcDir

Specifies the source directory of the supporting programs. The source directories for info files and data files are conducted from this directory using the assumption described in “Description” section. This argument is optional. Default is current directory, if not specified.

Menu commands:

File
Select Wafer/Lot . . .

Lets you open a wafer to view and may be edited if the user has the authority. You must enter the device name, lot no, sort ID, wafer no and subdirectory, so the program can locate the wafer file and its supporting info files. You must also specify the type of the wafer:
TSMC
IBM
UMC

This is used to indicate the file name convention. For IBM and UMC wafer, wafer ID is also required.

You can specify any or none of the following wafer's options:
Allow bin code 0—specifies that bin 0 is valid bin.
Left hand system—specifies that the wafer is a left-hand system wafer.
Sampling sort—specifies that the wafer is sampling sort.
Software bin—specifies that the data is using software bin instead of hardware bin.

You can also optionally specify a pre-process batch file to be run before the program opens this wafer. This gives you a chance to fix some wafer data problems programmatic ally.

Suffix Convention . . .

Lets you change the suffix of the file name for an edited wafer. Default is -F.

Naming Convention . . .

Lets you choose the output TSK format binary file name between network convention and floppy convention. The floppy convention is map_NNN.dat for each wafer file, where NNNN is a 4-digit number.

Transfer Lot Data . . .

Lets you transfer original, re-test, inspection and final TSMC format ASCII wafer files to srcDrive:\Company_Data, report files to srcDrive:\RPT, and final TSMC format ASCII wafer files to srcDrive:\user as a backup. Before the program transfer the data, it will give you a chance to save or quit the process, if you have made changes but have not saved it yet.

Run Post Processor . . .

Lets you have a chance to run a post process batch file after the lot data have been transferred.

Save Die Info . . .

Lets you save your editing.

Save Die Info As . . .

Lets you save your editing to a different file.

Save Color Info

This lets you save you change of the color scheme.

Save Color Info As . . .

This lets you save your changes of the color scheme to a different file.

Page Setup . . .

Lets you set-up your printer.

Print . . .

Lets you print the wafer map to a printer.

Exit

Exit the program.

Edit

IQC

Change the edit mode to IQC. Any mouse click on a good die will toggle between a good die and an IQC marked die. This command is dimmed if you don't have the authority to edit IQC dice. For supervisor only: This authority is defined in user.txt.

CP1

Change the edit mode to CP1. Any mouse click on a good die will toggle between a good die and a CP1 marked die. This command is dimmed if you don't have the authority to edit CP1 dice. For supervisor only: This authority is defined in user.txt.

CP2

Change the edit mode to CP2. Any mouse click on a good die will toggle between a good die and a CP2 marked die. This command is dimmed if you don't have the authority to edit CP2 dice. For supervisor only: This authority is defined in user.txt.

INK

Change the edit mode to INK. Any mouse click on a good die will toggle between a good die and an INK marked die. This command is dimmed if you don't have the authority to edit INK dice. For supervisor only: This authority is defined in user.txt.

V/M

Change the edit mode to V/M. Any mouse click on a good die will toggle between a good die and a V/M marked die. This command is dimmed if you don't have the authority to edit V/M dice. For supervisor only: This authority is defined in user.txt.

P-S L/A

Change the edit mode to P-S L/A. Any mouse click on a good die will toggle between a good die and a P-S L/A marked die. This command is dimmed if you don't have the authority to edit P-S L/A dice. For supervisor only: This authority is defined in user.txt.

Inkless File Output . . .

Tells editor.exe to also produce inkless output file. You can choose either ANIM, SPIL or ASE format inkless output. The old and new SPIL formats are obsolete and are only there for backward compatibility.

Data Unlocked/Data Locked

Lets you lock or unlock the data file. This command is dimmed if you don't have the authority to unlock the data files. For supervisor only: This authority is defined in user.txt.

Display Options . . .

Lets you change the display layout. You can choose to show the wafer map as a whole or in quadrants. You can also choose to show the inspection logging form or hide it.

Security

Set Password . . .

This command does nothing if you don't have the authority to unlock the data files. This authority is defined in user.txt. You must enter the password to be able to change the notch and/or change the pass bin code(s). For supervisor only: This password is defined in map.inf for this lot.

Notch

This menu is dimmed if you don't have authority to unlock the data files and if you do not set the correct password. In this case, the pull-down menu is not shown.

0 degree

Lets you set the notch to be 0 degree. A check mark next to the left of this command indicates it's the notch for this wafer.

90 degrees

Lets you set the notch to be 90 degrees. A check mark next to the left of this command indicates it's the notch for this wafer.

180 degrees

Lets you set the notch to be 180 degrees. A check mark next to the left of this command indicates it's the notch for this wafer.

270 degrees

Lets you set the notch to be 270 degrees. A check mark next to the left of this command indicates it's the notch for this wafer.

Pass_bin

Lets you change the pass bin code list. This menu is dimmed if you don't have authority to unlock the data files and if you do not set the correct password. In this case, the pull-down menu is not shown.

A list of pass bin will be shown in this pull-down menu. Each is a selectable menu command. Each click toggles the bin between being a pass bin code and being a fail bin code. A check mark next to the left of the command indicates it's a pass bin code. Example:
1
2
3

Size.exe (DOS program)

Description: creates a trimmed version of the source TSMC format ASCII wafer file. It removes any duplicated die in FIFO order, i.e., the last duplicate is kept while any previous duplicate is removed. The newly created file will be named the same as the source file with either a given suffix or default suffix.
Usage: size [-xsuffix] srcTsmcAsciiFile

Example: size -x-F D:\tsmc\EDAdata\3880\D5M08.1\*.*

Arguments: All optional arguments' order is insignificant. All required arguments' order is significant and must be specified after all optional arguments.

-xsuffix

Specifies the suffix of the output TSMC format ASCII wafer file name. This argument is optional. Default is “-R”, if not specified. Ex.“D:\tsmc\EDAdata\8123\DA0662.00\DA0662.00-1-01-R”.

srcTsmcAsciiFile

Specifies the input TSMC format ASCII wafer file. This file name can be full name or partial name and can include wild card characters.

Rotate.exe

This program is renamed to RotateWM.exe. Please refer to the description for RotateWM.exe

Autoftp.exe (DOS program)

Description: automatically logs on to the given ftp site with the given user name and password, performs either “get” or “put” operation depending on what the user specifies, then logs off when it is done. The ftp operation is performed in binary mode.
Usage: autoftp [{putlget}]-machine RemoteHostName -user RemoteUsrName -password RemotePswd

-dir RemoteDirectory {-filePatternfilePattern|-timeStamp MMDDhhmmYYYY}

Example: autofpt get-machine ftp.yahoo.com -user foo -password foo1234 -dir outgoing -filePattern*.dat

Example: autofpt put -machine 123.45.67.89 -user foo1 -password foo56 -dir incoming

-timeStamp 121108002000

Arguments: All arguments' order is insignificant. This is the only program in this documentation that all its arguments are case sensitive. However, the program name is case insensitive.

put, get

Specifies the ftp operation to be performed. This argument is optional. Default is put, if not specified.

-machine RemoteHostName

Specifies the ftp site to log on. A space is required between -machine and RemoteHostName.

-user RemoteUsrName

Specifies the user name to log on. A space is required between -user and RemoteUsrName.

-password RemotePswd

Specifies the password to log on. A space is required between -password and RemotePswd.

-dir RemoteDirectory

Specifies the source directory on ftp site for a “get” operation, or the destination directory on ftp site for a “put” operation. A space is required between -dir and RemoteDirectory.

-filePattern filePattern

Specifies the files to get. A space is required between -filePattern andfilepattern. You must specify this pair of arguments for a “get” operation. It is ignored for a “put” operation.

-timeStamp MMDDhhmm YYYY

Tell the ftp command to put all files whose last modification time is later than MMDDhhmmYYYY. A space is required between -timeStamp and MMDDhhmmYYYY. You must specify this pair of arguments for a “put” operation. It is ignored for a “get” operation. MMDDhhmmYYYY is interpreted as the follow:
MM, 2-digit number range from 01-12, specifies the month; January=01, February=02, and so on.
DD, 2-digit number range from 01-31, specifies the day of the month.
hh, 2-digit number range from 00-23, specifies the hour.
mm, 2-digit number range from 00-59, specifies the minute.
YYYY, 4-digit number range from 1900-9999, specifies the year.

Rotatewm.exe (DOS program)

Description: rotates the given wafer, in TSK format binary file, for the given degrees clockwise.
Usage: rotatewm [-sSrcPath]-oDstPath {90↑-90} SrcTskBinaryFile

Example: rotateWM -sC:\monitor\8123\p017\DA0662.00-oC:\monitor \8123\p017\DA0662.00\rotate 900*

Arguments: All arguments' order is significant except that the order of -s and -o can be interchanged.

-sSrcPath

Specifies the source directory. This can be a full path or a partial path. This argument is optional. Default is current directory, if not specified.

-oDstPath

Specifies the destination directory. This can be a full path or a partial path.

{90|-90}

Specifies the degrees of the angle to rotate clockwise. So, if “-90” is specified, the wafer will be rotated 90 degrees counter-clockwise.

SrcTskBinaryFile

Specifies the source TSK format binary wafer file to be rotated. This file name can contain wild card characters.

Findfile.cpp

Description: the template of source code for searching all files in current directory.

Winftp.exe (Win32 program)

Description: periodically logs on to the given ftp site, checks for files in the given source directories specified in the instruction file, and performs the “put” operation. Optionally, it will also duplicate the incoming files to the corresponding directories in the network drive(s). All processed files are renamed with a file modification time stamp and moved to srcPath\backup.
Usage: winftp \d {-tN|-hN}-iInstructFile [-fNetDrive.lst]

Example: winftp -t1 -ic :\monitor\map\ioumc.txt -fc :\monitor \map\netdrive.txt

Arguments: All arguments' order is insignificant.

-tN, -hN

Specifies the frequency to logon to ftp and perform any necessary operation according to the instruction file. N is the number of minutes if “-t” is specified, or hours if “-h” is specified.

-iInstructFile

Specifies the instruction file. This file name can be either full name or partial name. This file must be an ASCII text file. The file contains lines in the following format:

| keyword | Field1 | Field2 | Field3 |
|---|---|---|---|
| I: | ftp_site | user_name | password |
| DI: | srcPath | | |
| DO: | dstPath | | |

I: followed by ftp_site, user_name and password specifies the ftp site address, the user name and password for logon.nes. The file can contain multiple “I:” lines. Each “I:” line can be followed by 1 or multiple pairs of “DI:” and “DO:” lines.

DI: followed by SrcPath specifies the source directory in local machine. This path can be either full path or partial path.

DO: followed by dstPath specifies the destination directory in ftp site. This path can be either full path or partial path.

“DI:” and “DO” lines must be specified in pair, i.e., a “DI:” line must be followed by a “DO:” line and a “DO:” line must follow a “DI:” line.

All keywords start at the first character of the line. The keyword and each field are separated by either blank(s) or tab.

The following is an example of the file contents of an instruct file:
I: 192.168.6.124 foo foo1234
DI: C:\monitor\map\test
DO: /user2/sunrise/vlsi/foo/winftp/test1
DI: C:\tsmc\test
DO: /user2/sunrise/vlsi/foo1/winftp/test2

-fNetDrive.lst

Specifies the network drive list to duplicate the incoming files to. This argument is optional. The file format is the same as that of “-f” argument in Autoprocess.exe. Please refer to its description for more detail.

Lacido.dll (Win32 DLL)

Description: the shared library that contains routines to check if a given Wafer Map Editor software is registered and if a given Wafer Map Editor software is authorized to be used on the current machine. These routines are called by all programs mentioned in “Software Specification” documentation that the user must run WinInstall.exe to gain authorization of the usage.

DosInstall.exe (DOS program)

Description: installs all objects required to run all DOS programs, mentioned in “Software Specification” documentation that are subject to authority check.
Usage: dosInstall MMDD
   Arguments:

MMDD

Specify the date of the installation.

MM, 2-digit number range from 01-12, specifies the month; January=01, February=02, and so on.

DD, 2-digit number range from 01-31, specifies the day of the month.

WinInstall.exe (Win32 program)

Description: installs all objects required to run all Win32 programs, mentioned in “Software Specification” documentation, that are subject to authority check. It requires the authority to run it. It shows the amount of authorized time left to run each of those programs and lets the user recharge or change them.
Usage: WinInstall
   Arguments: None.

Uninstall.exe (Win32 program)

Description: removes all objects required to run all DOS programs, mentioned in “Software Specification” documentation that are subject to authority check.
Usage: uninstall
   Arguments: None.

The following is a description of the present invention as illustrated in the figures.

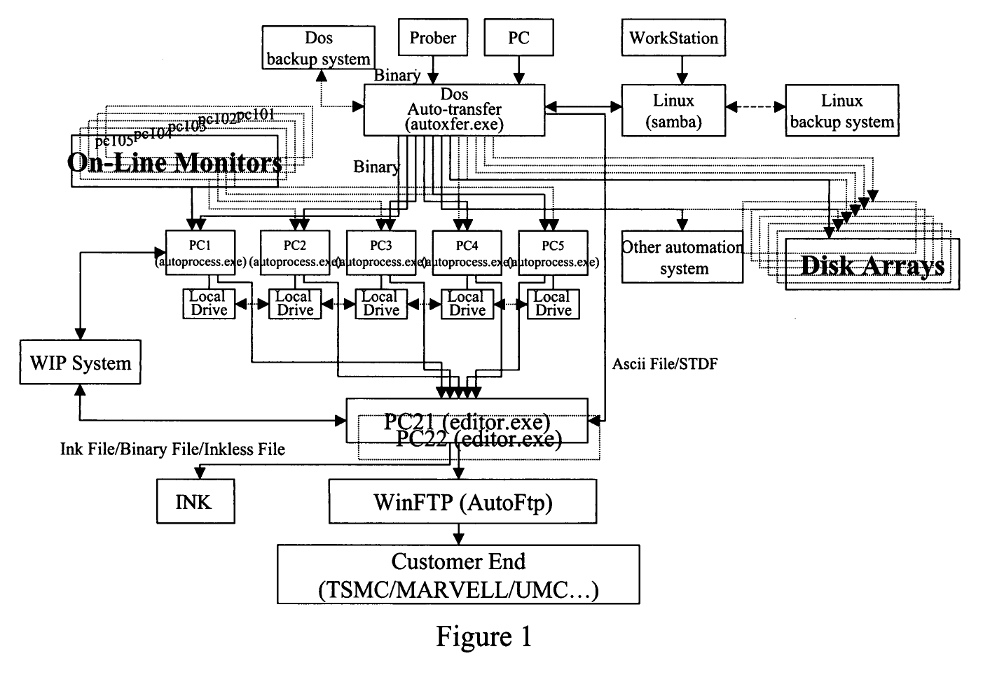

As shown in FIG. 1, the autoxfer program runs under PC DOS or Windows and the PC connects via a network to another with PC Linux installed. The PC running Linux has Samba software installed so that the DOS PC can treat the Linux PC as a network drive. The DOS PC is responsible for receiving data files from any PC based testers or probers in the testing area. The Linux PC is responsible for receiving data files from any Unix based systems.

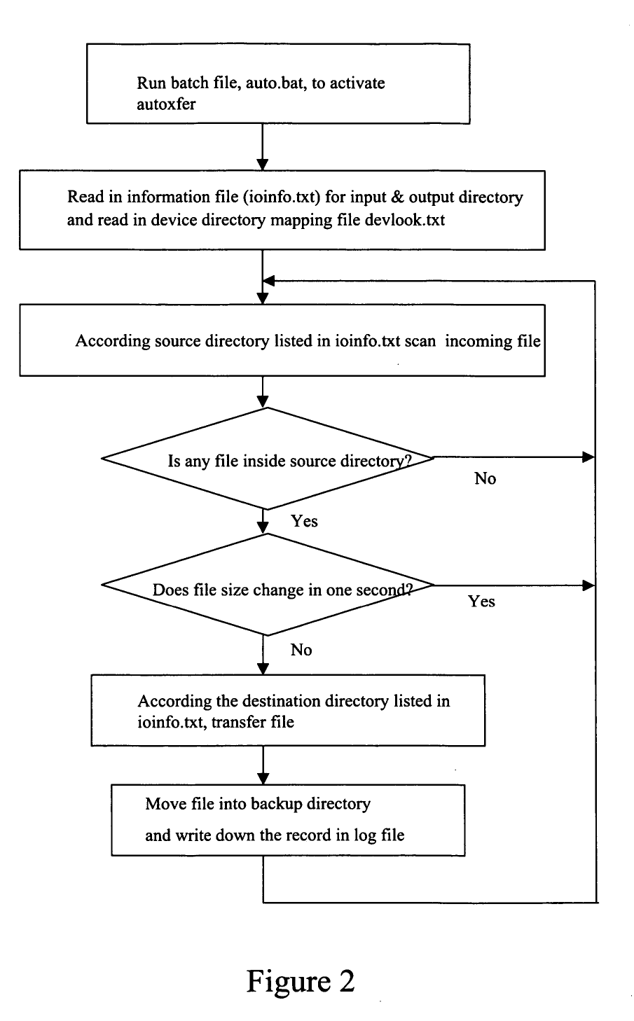

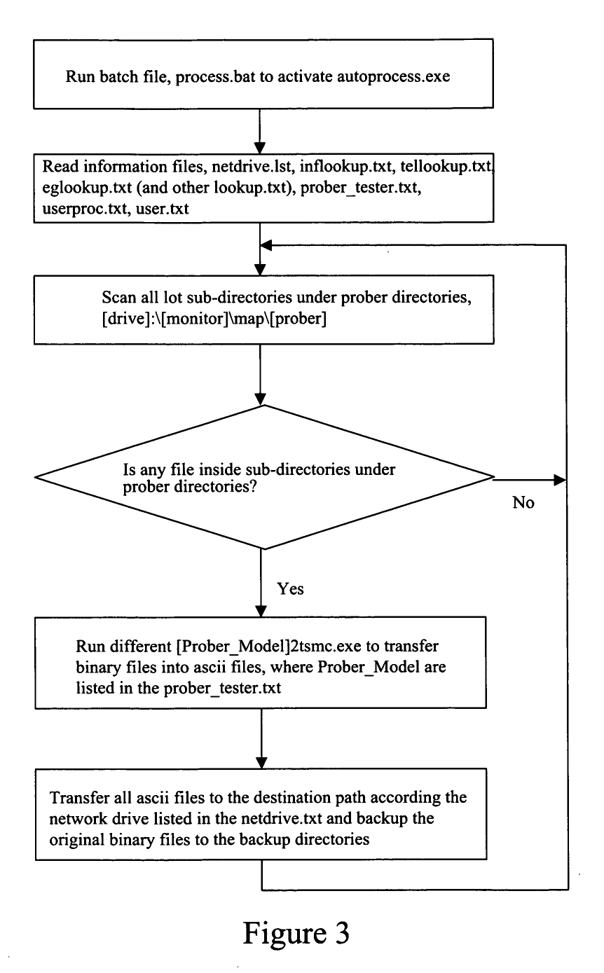

The autoxfer.exe program following instructions in an information file (ioinfo.txt) sends data files under scanned directories to other systems as shown in FIG. 2. Therefore prober data are frequently and simultaneously sent to multiple systems running autoprocess.exe. After systems PC1, PC2, PC3, PC4, PC5 . . . running autoxfer.exe have received files, autoprocess.exe scans incoming data files once every minute. If it finds a data file, it converts the binary file into an ASCII file, then moves the original binary file into the back-up directory and also moves the conversion output into a fixed directory as shown in FIG. 3.

According to network drive assignment, files are sent to local drives as well as an editor PC to facilitate editing. The systems PC1, PC2, PC3, PC4, PC5 . . . which run autoprocess.exe all have identical internal sub-directory name and contents, so every pair of PCs can back up each other by assigning network drives. Two PCs running autoprocess are set up to transfer converted data to two editing PCs; PC21 and PC22. So beside the local drives of the PCs running autoprocess, data for an editing PC also exist on PC21 and PC22. Therefore the system has a complete backup and machines going down are not a problem. Every PC running autoprocess.exe can connect to up to ten on-line monitor PCs by using drive mapping of network drives. The ten-monitor limit is imposed by Windows. So PC100, PC101, PC102, PC103 . . . PC200 on the production line can be used as on-line monitors. Batch files can be set up there and the drive mapping file in C drives of the PCs controls drive mapping between monitor PCs and the autoprocess PCs. The monitors running on the on-line PCs see the same thing as the autoprocess PCs. The monitors run on the on-line PCs but the database resides on the autoprocess PCs. All data generated from the production line are available on the monitors of the on-line PCs within one minute. If data are not available, it means either data files have not been generated or transfers were not successful.

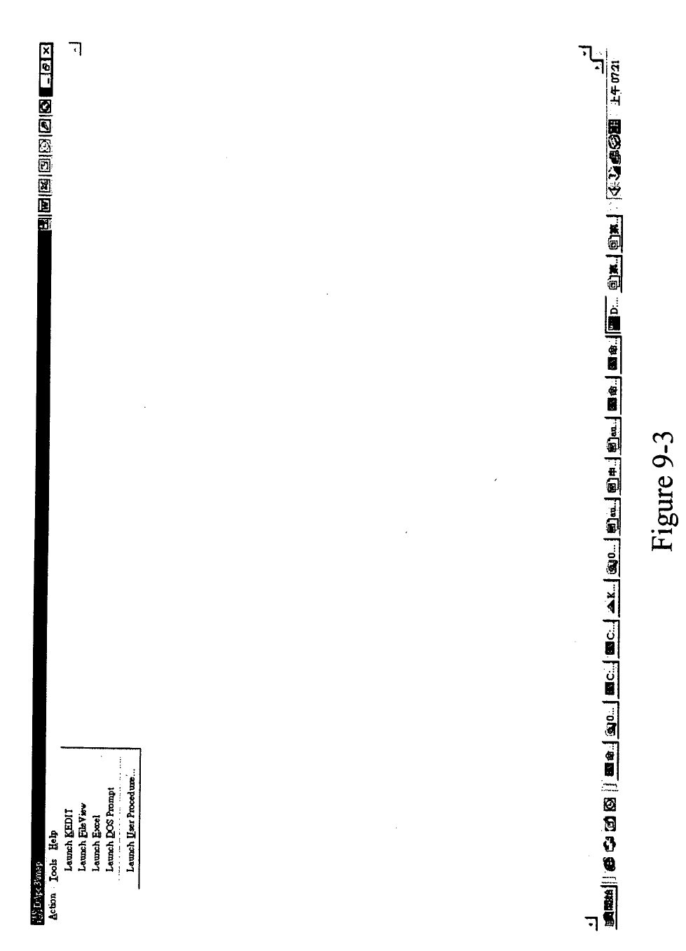

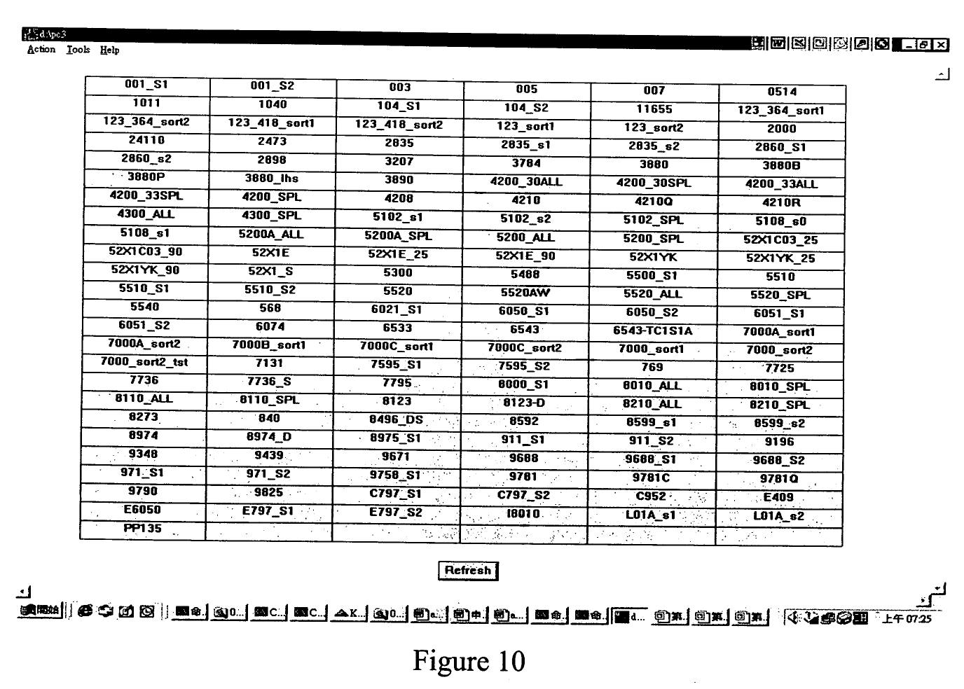

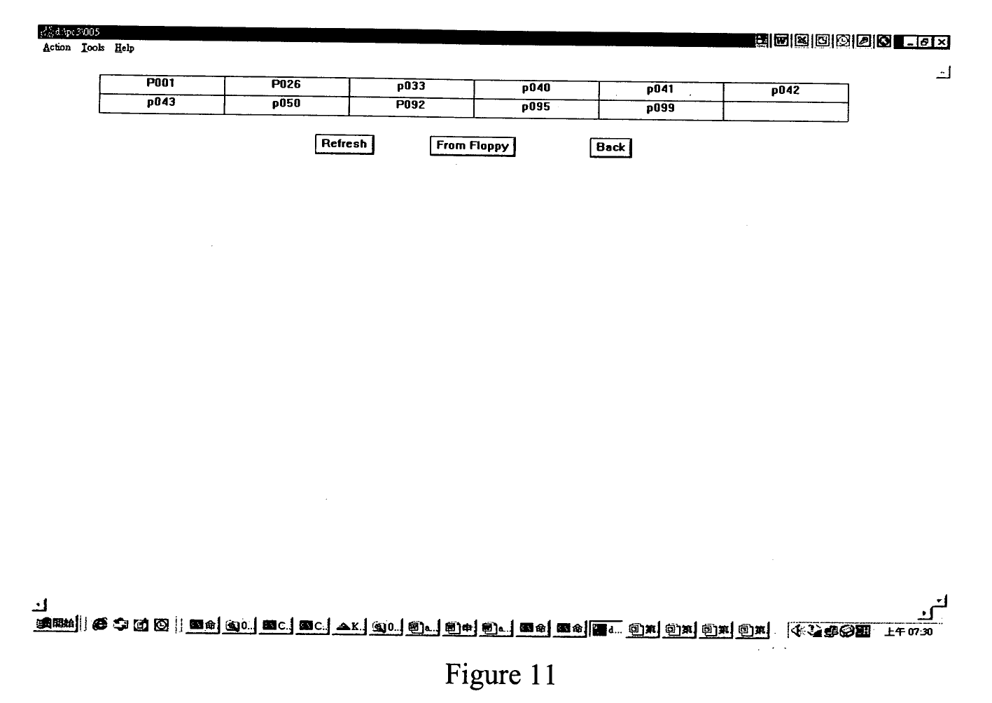

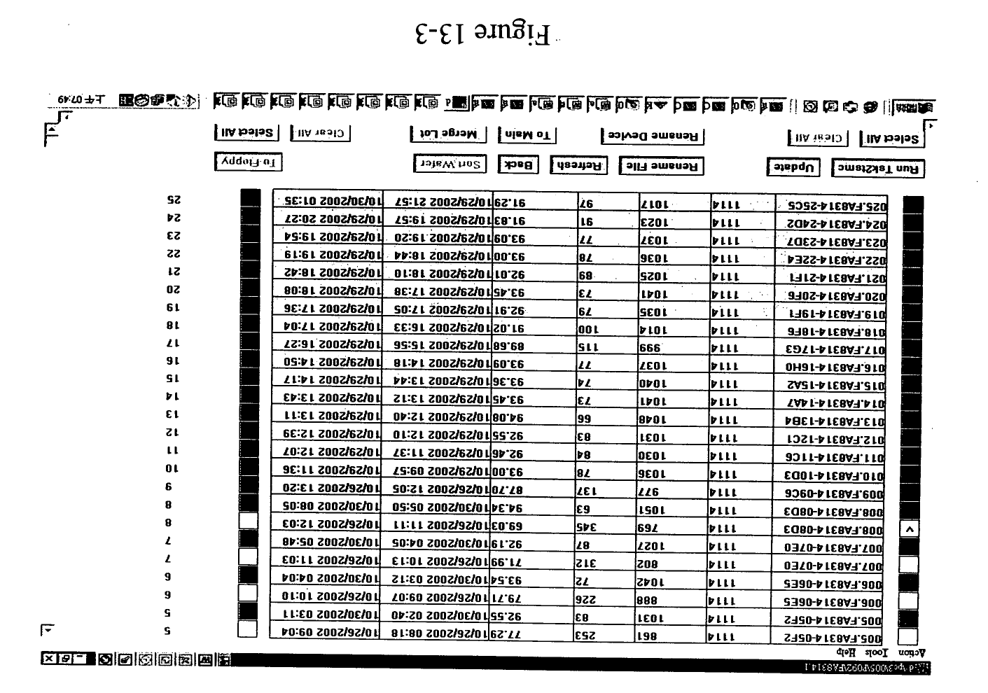

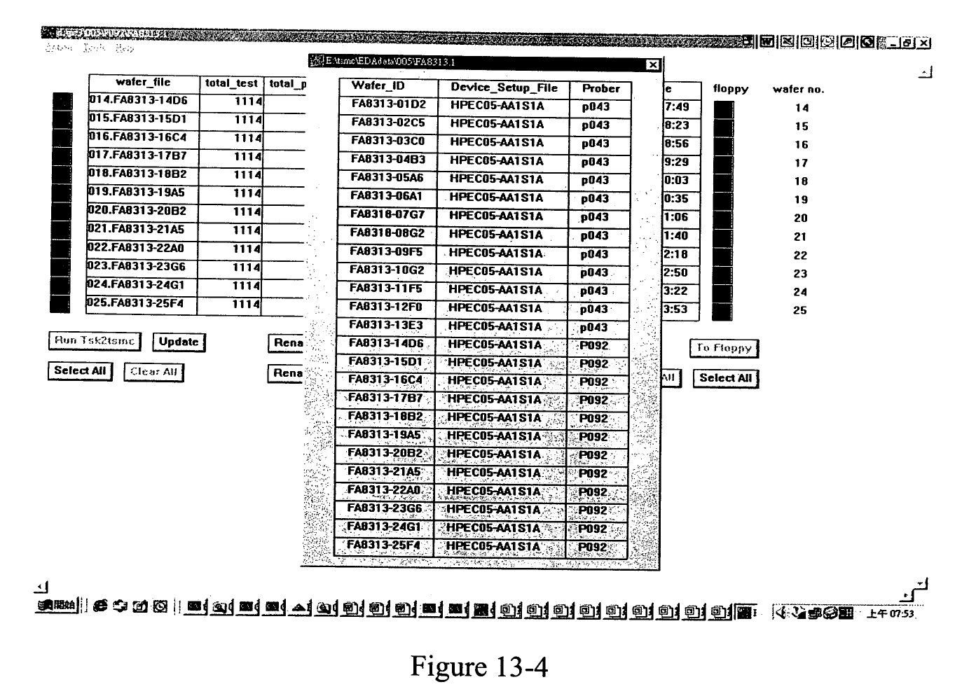

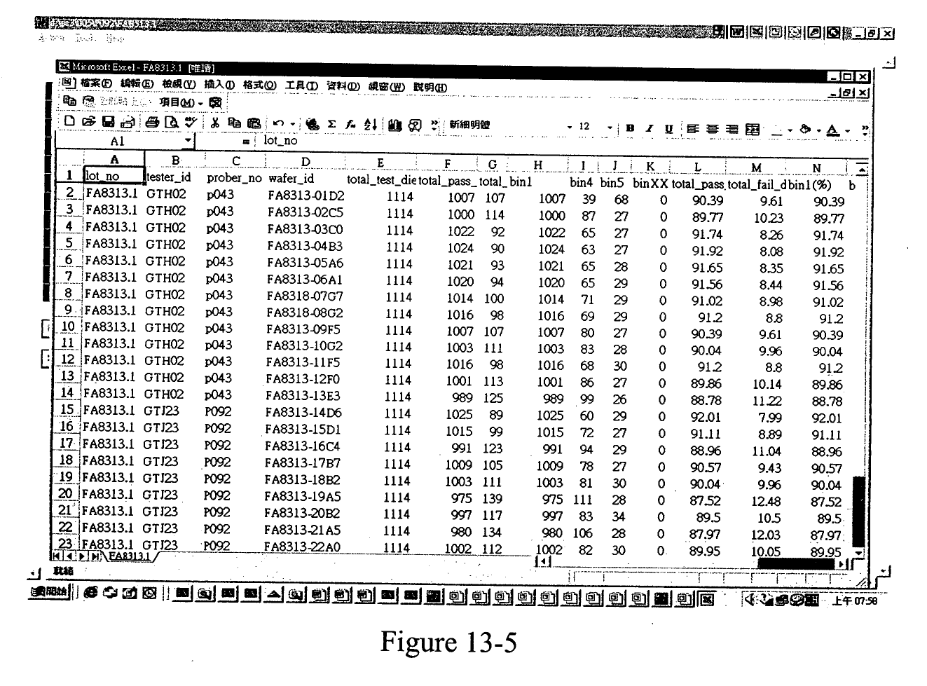

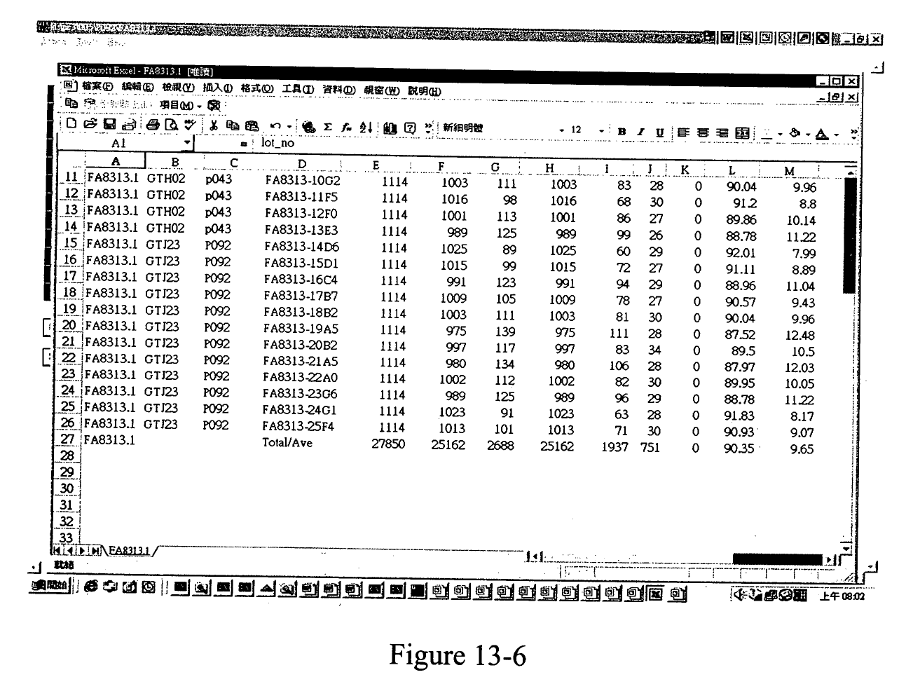

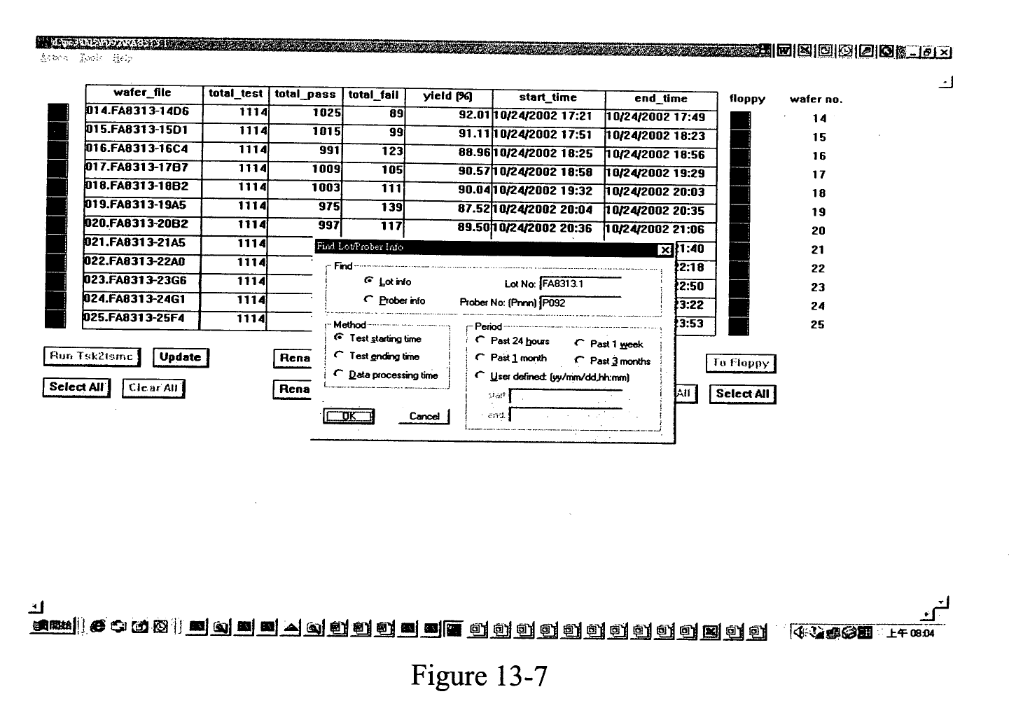

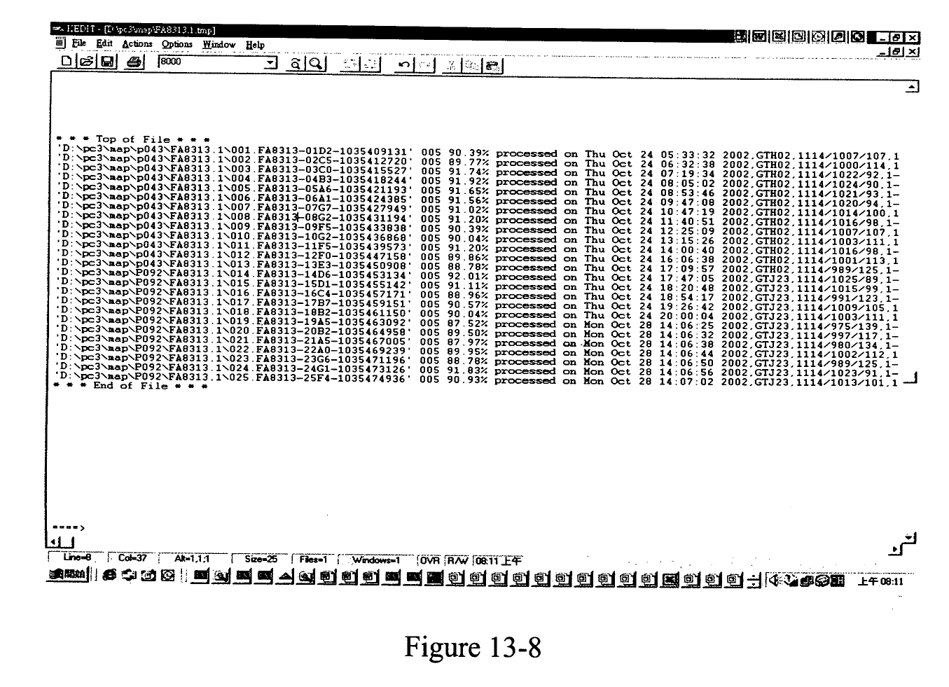

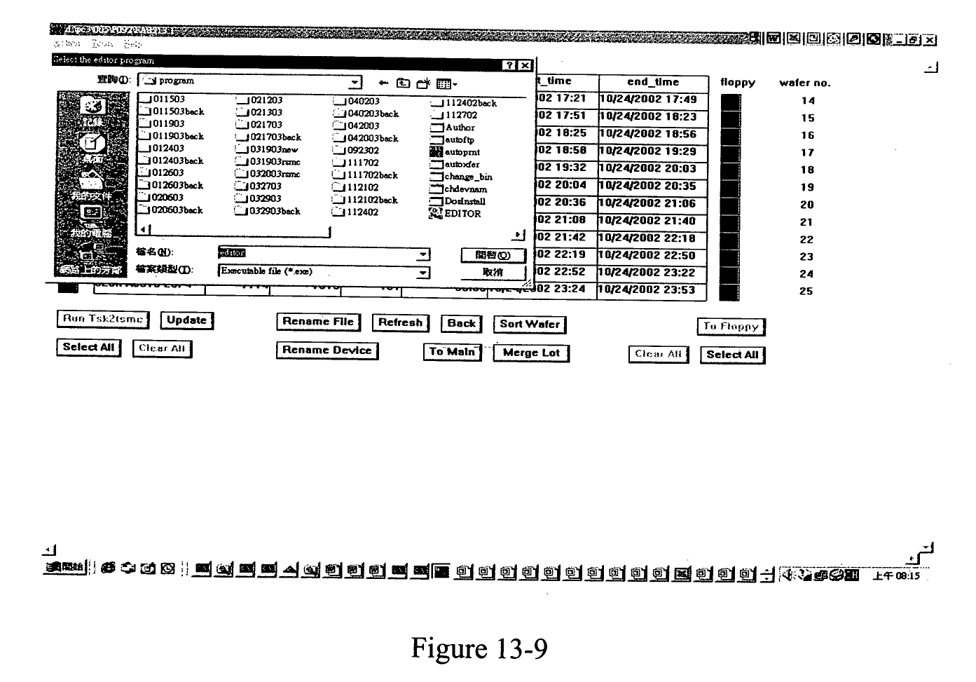

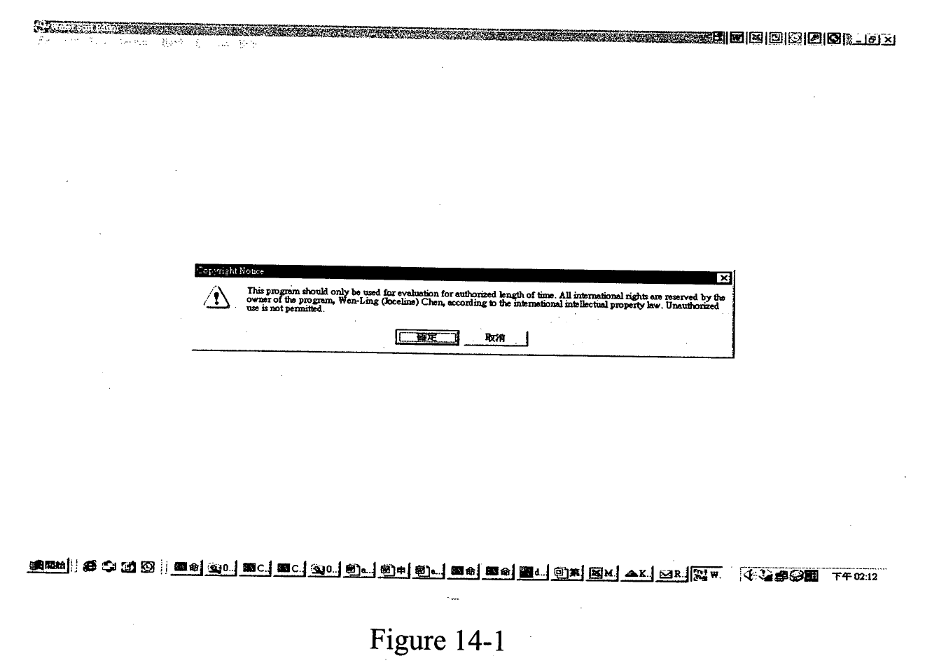

If any test has no data file, it means everything needs to be retested. There will be many risks in retesting. For example, one or two additional probing marks will be made during probing. Generally speaking, customers do not allow more than three probing marks since it would cause difficulty in wire bonding of pads. If a low yield wafer is to be retested normally, retesting is targeted at failed dies only, but it requires a raw data file for the whole wafer. This issue can be solved by the on-line monitor in FIGS. 9, 10, 11, 12 and 13. It is only required to click on the right on FIG. 13-2 to select the wafer that needs to be retested, and to click the “floppy” button so that all retest data will go onto a floppy. A retest can be done as soon as the floppy is inserted into a prober. Operations like this are extremely important to a production line since once any problems happen, data must be available immediately in order for the problem to be fixed.

After data are sent to an editing PC, a product engineer can use the network to connect to either one of the two editing PCs that mutually back up each other. The engineer can perform file transfer based on status of the wafer map check. All engineers using this editing PC can configure their local PCs to be on-line monitors and work on their PCs without affecting each other. Some engineers only look at test results, some process wafer data file for a whole lot. All final results are shown in FIG. 13-3. In this figure, if the color of the check box on the left is white, it means the data are in the backup directory; if the color is green, it means data are in the working directory. In this case after moving the mouse to the check box on the left of the figure to select a wafer, a user moves the mouse to the “Run Tsk2tsmc” button and clicks, and the autoprocess.exe program will call tsk2tsmc.exe to perform data conversion again for the wafer.

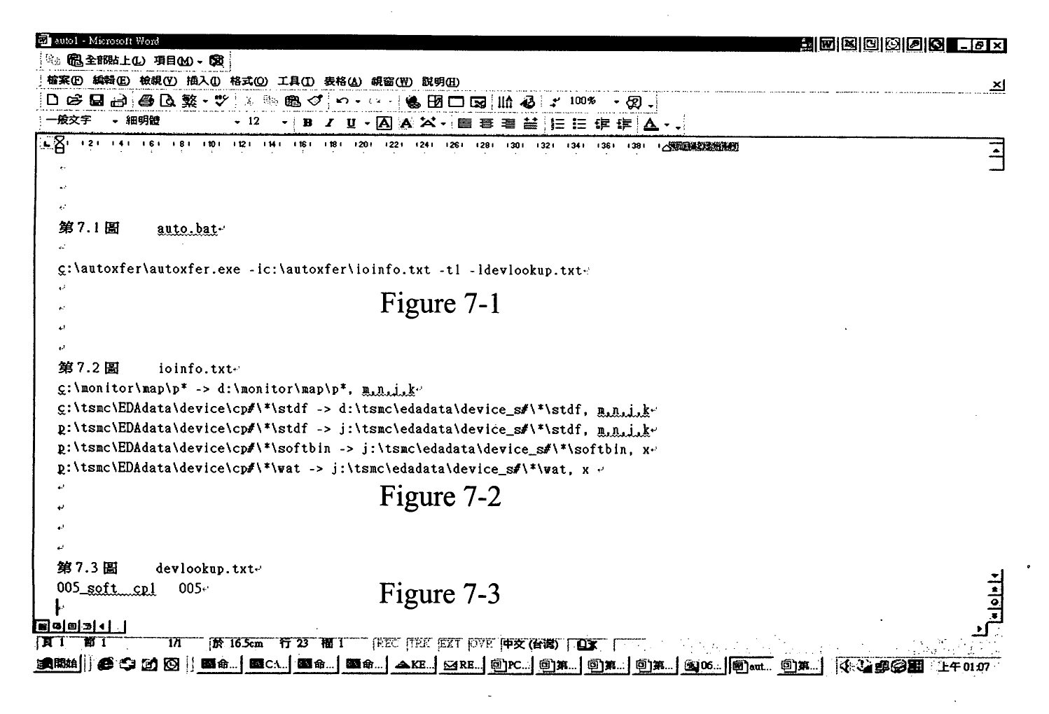

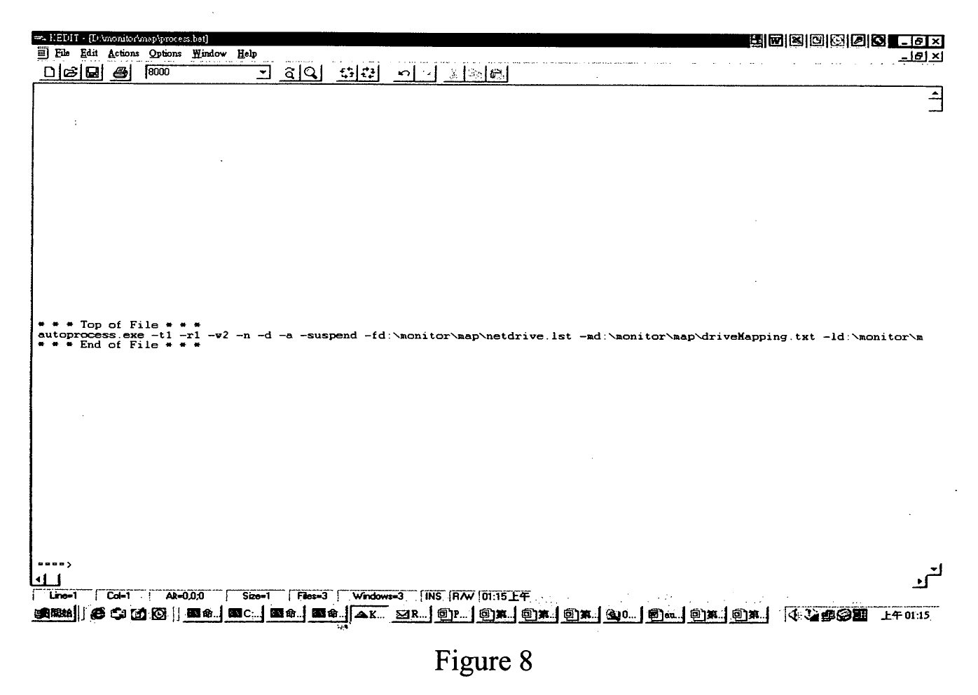

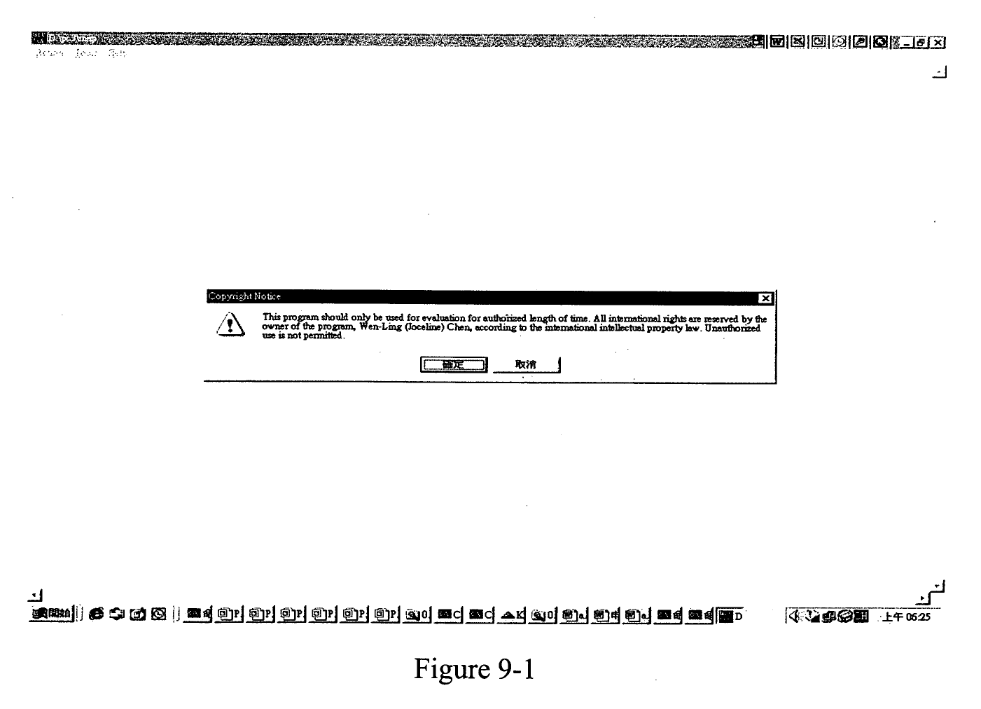

After conversion, the user clicks the refresh button and the data will be shown again at the bottom of the screen and the associated check box will be green indicating the data are in the working directory. FIG. 7-1 shows batch file auto.bat used during execution of autoxfer.exe.

FIG. 7-2 shows the input and output information file (ioinfo.txt) of autoxfer.exe. From this file it can seen that any file scanned from c:\monitor\map\p* can be transferred to sub-directories corresponding to d:\monitor\map\p*. And the asterisk “*” in p* is a wildcard, meaning p* can be either one of p001, p002, p003 . . . p100, which are data from different probers. In path d:\monitor\map\p*m,n,j,k the “m,n,j,k” means drives m, n, j and k. The path is the same as that of the d drive. Hence there is no need to write another four lines. In addition the information file (devlookup.txt) shown in FIG. 7.3 is a corresponding look-up table. The “\device\cp#” in ioinfo.txt is the incoming “directory\005-soft\cp1” and the out-going “directory\device_#s” is “\005” (defined by devlookip.txt).

By this conversion, any data from the production line can be placed into correct sub-directories through autoxfer.exe for use by the software of the invention. If a transfer is not successful, the file whose transfer failed is put into a sub-directory corresponding to the name of the failing drive for transfer in the next scan. Files in the source directory are still moved into the back-up directory after the scan.

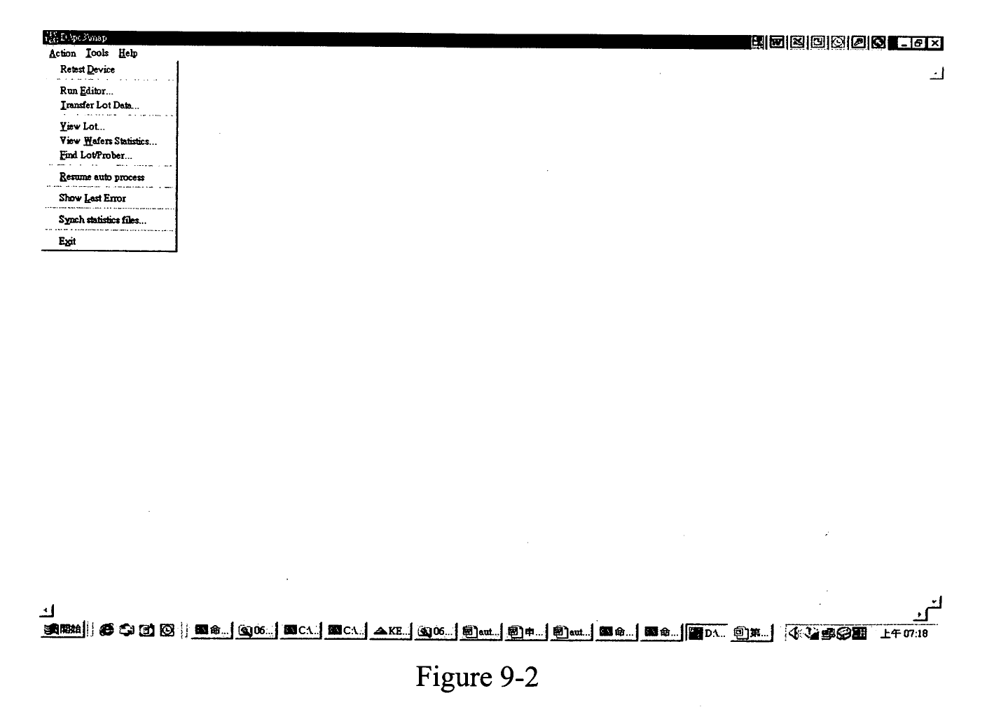

FIG. 8 shows that parameters in all command lines which are explained in detail in the software description. FIG. 9-1 shows the message of ownership of this program once the editor program is executed. FIG. 9-2 and FIG. 9-3 show different pull down menus under “Action” and “Tools”. When pull down menu “Retest Devices” is selected, FIGS. 10 to 13-1 explain how by following sub-directory hierarchy in the database to systematically enter relevant screens. Such as to see test results and to take related actions, like selecting wafers with small squares on the left of FIG. 13-2 and generating retesting data on floppies by clicking the button in the lower right.

In addition an operator can select a wafer using check boxes on the left, then clicking the button in the lower left to execute the binary to ASCII program to select correct wafer yield data into the working directory (indicated by green in the square) shown in FIG. 13-3.

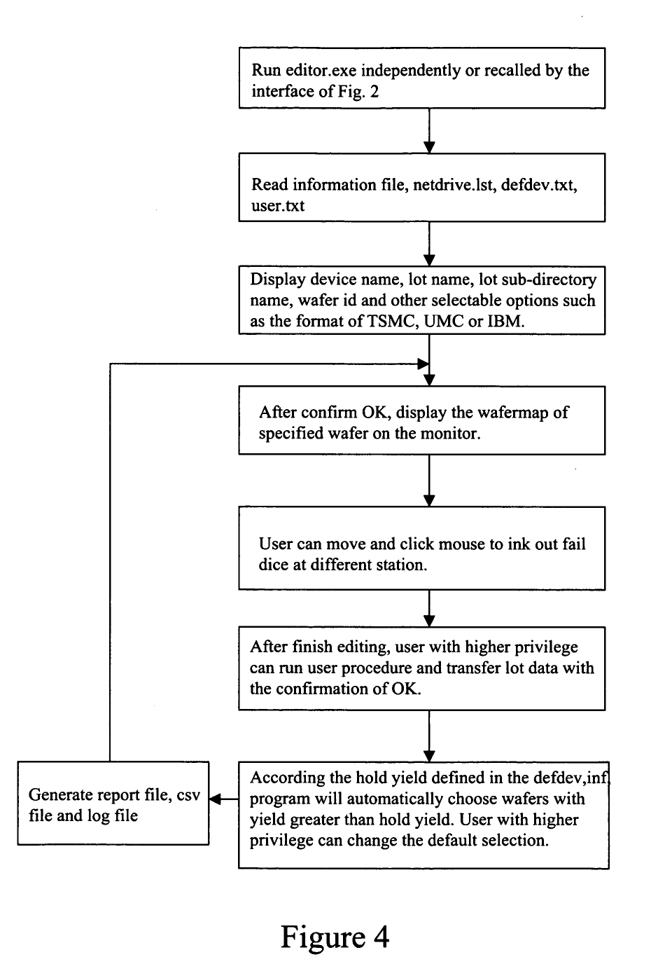

FIG. 13-4 shows the window if “View Lot” pull down menu is selected and it shows more detailed information about device setup file name and prober number.

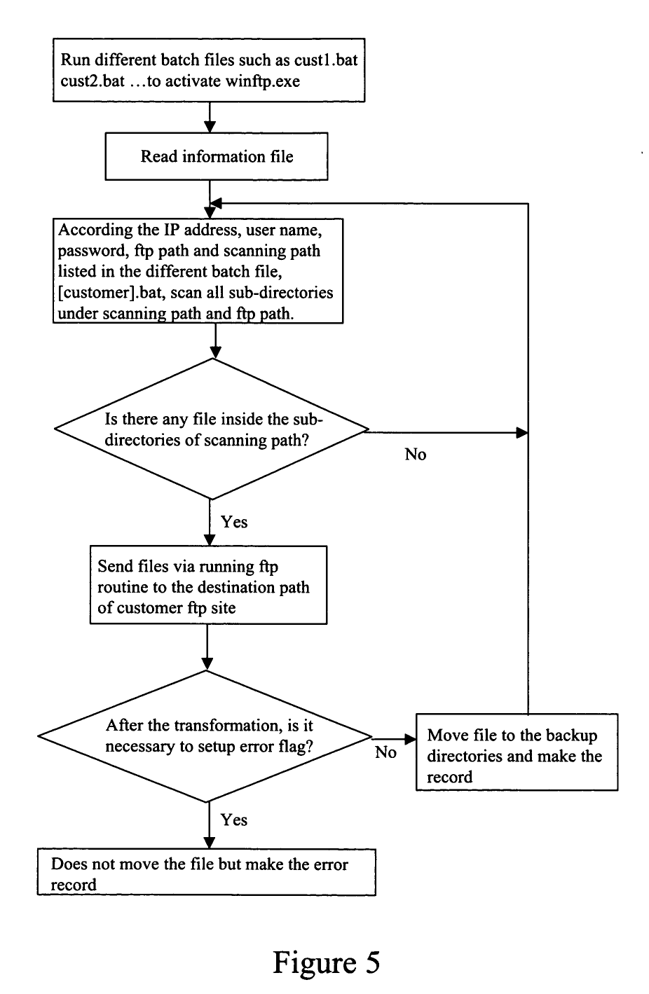

FIG. 13-5 and FIG. 13-6 show all records about this lot if “View Wafers Statistics” pull down menu is selected so that user knows everything about this lot including several incomplete test data files for the same wafer.

FIG. 13-7 shows the window if “Find Lot/Prober” menu is selected so that a user can specify all related concerns to find out the data file. FIG. 13-8 shows the finding of the searching from data base file. FIG. 13-9 shows the window if “Run Editor” is selected. Then, the editor program under a different directory can be selected by the user and the editor program can be invoked.

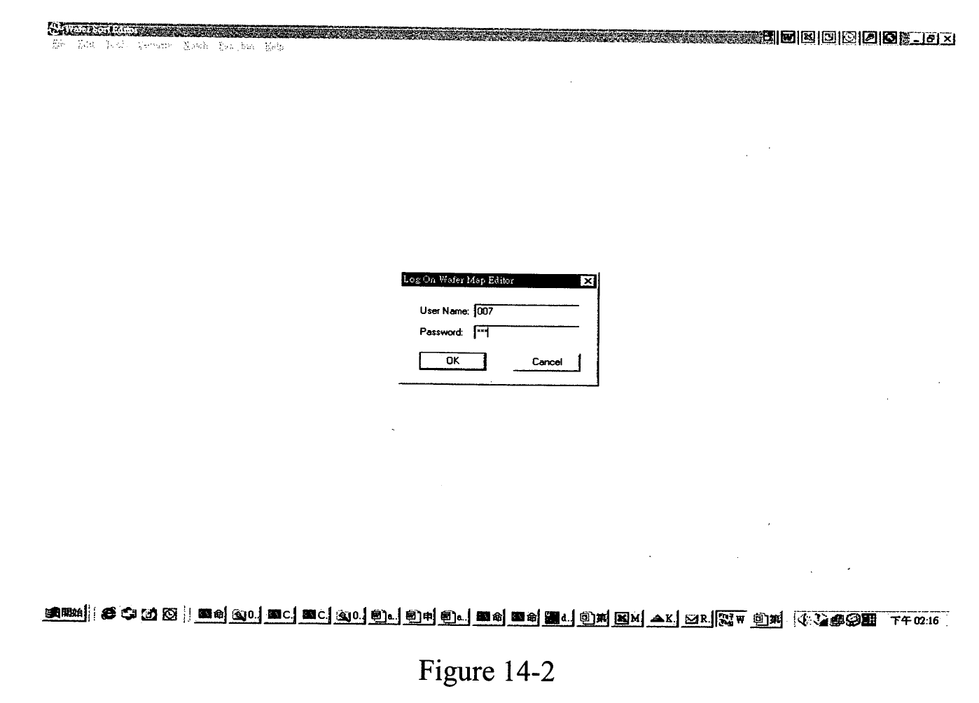

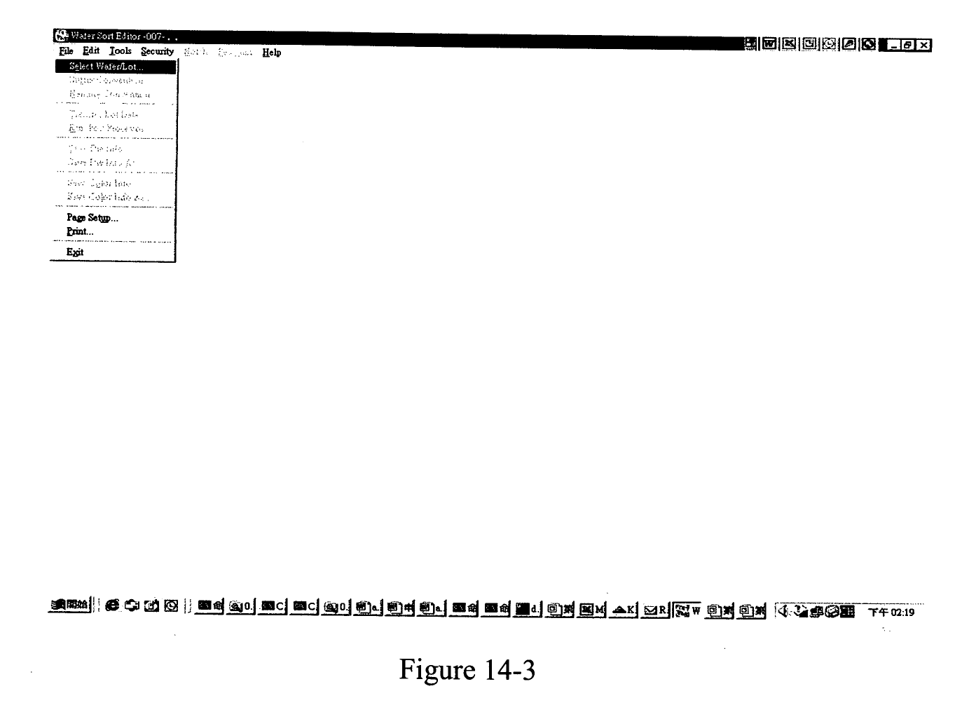

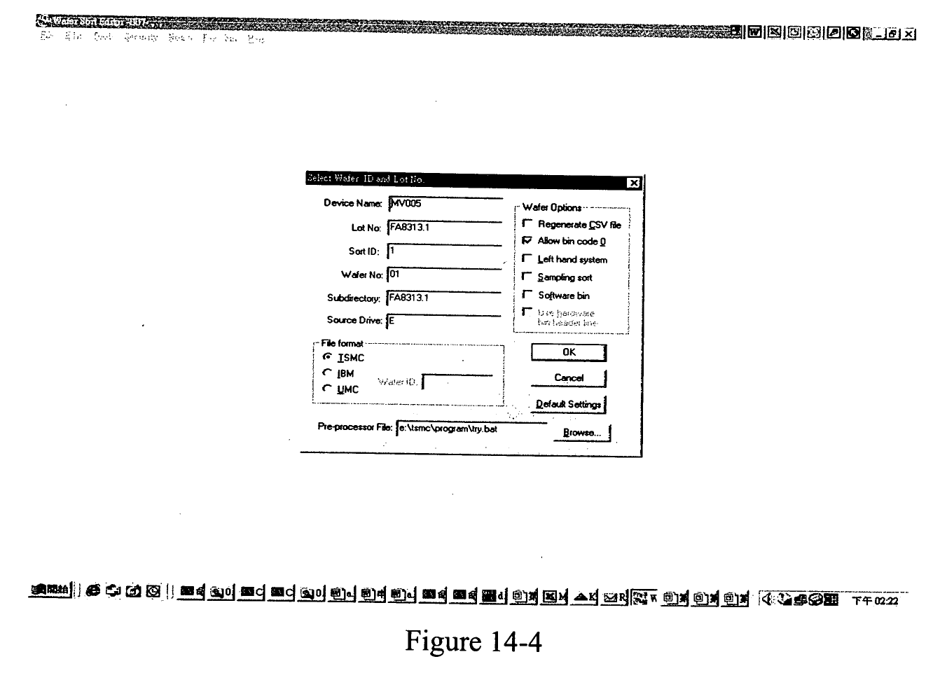

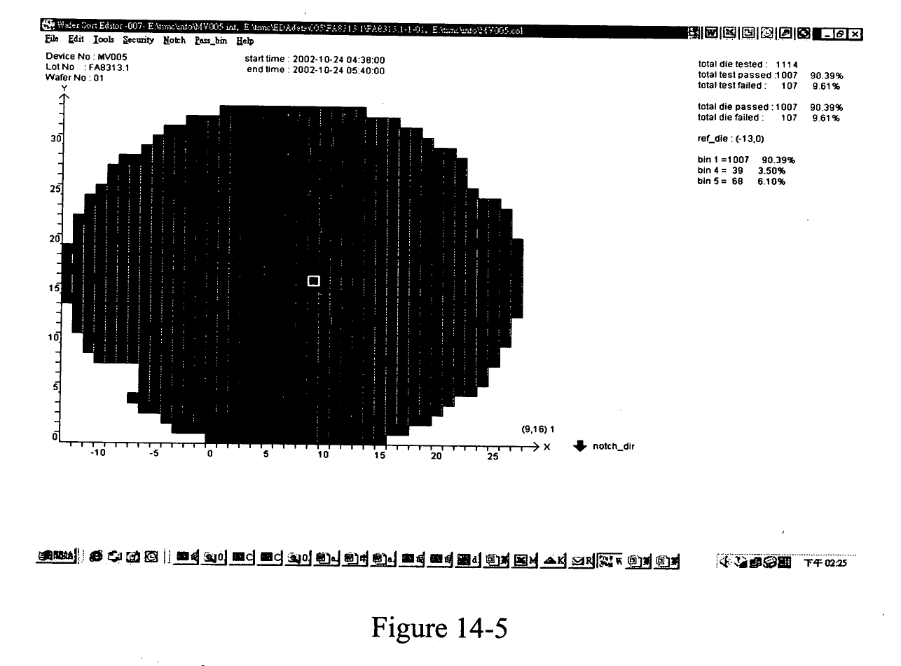

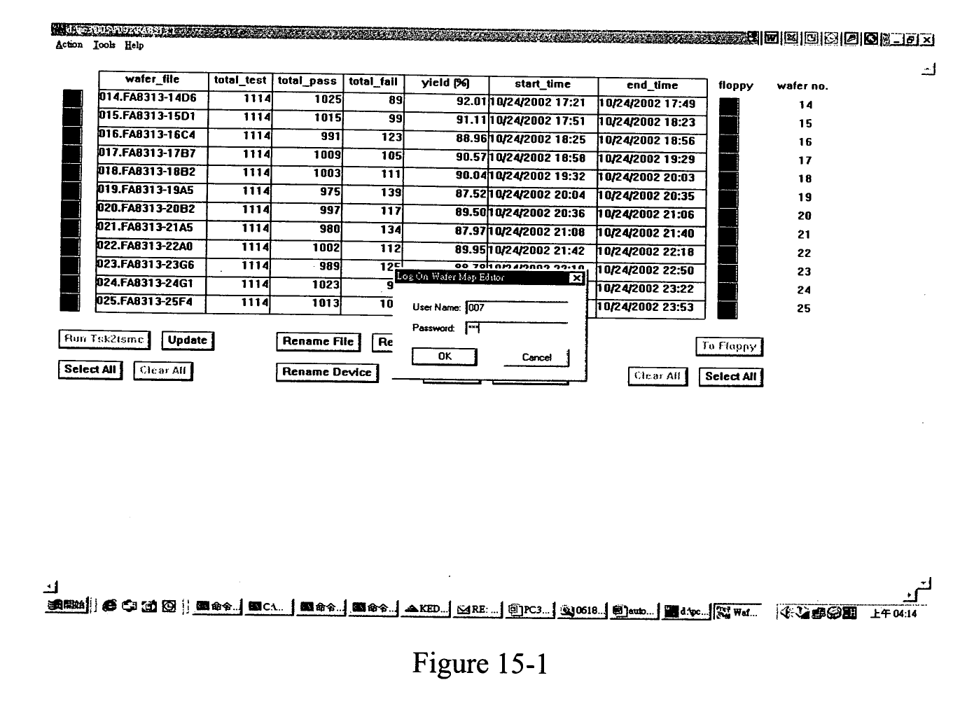

FIG. 14 shows the screen display when the editor program is in use. FIG. 14-5 shows the third function software, which has its own routines for displaying wafers, instead of using routines in Windows. This enables effective control of screen coordinates of every die on a wafer and allows clicking selection by moving the mouse cursor over the die. When the mouse pointer is moving over the wafer map, the lower right corner of the map shows the wafer coordinate and binning number of the die below the cursor. The die under the cursor is also highlighted with a white frame.

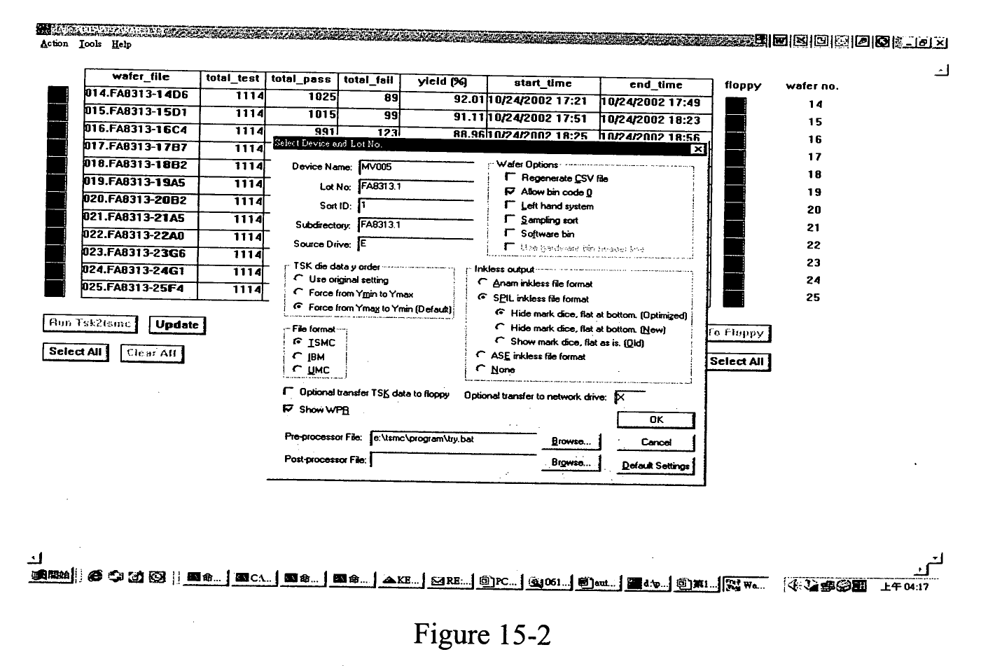

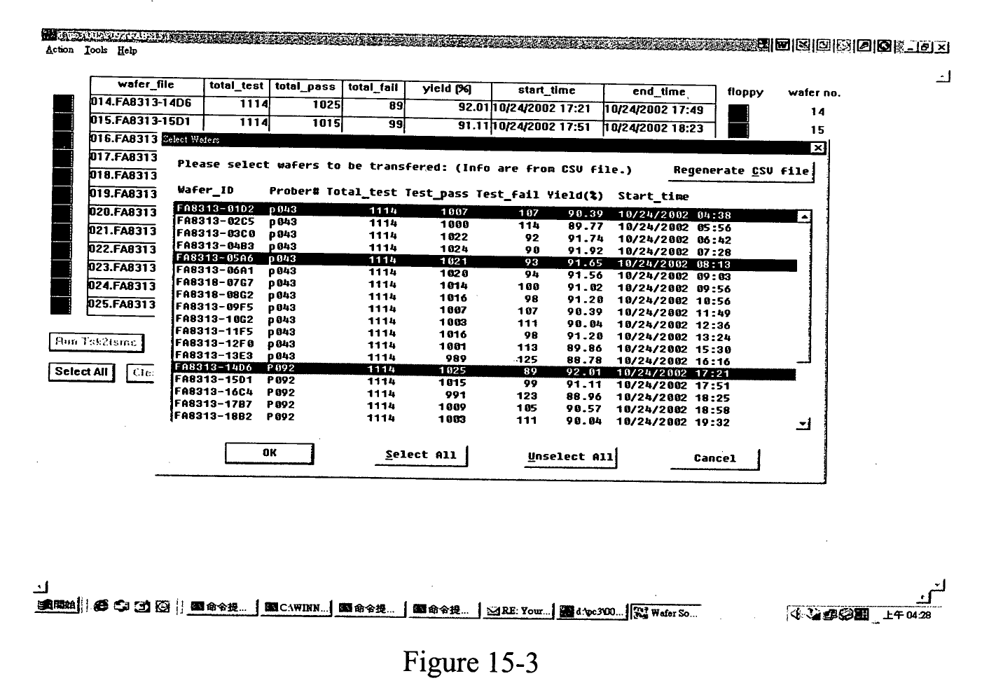

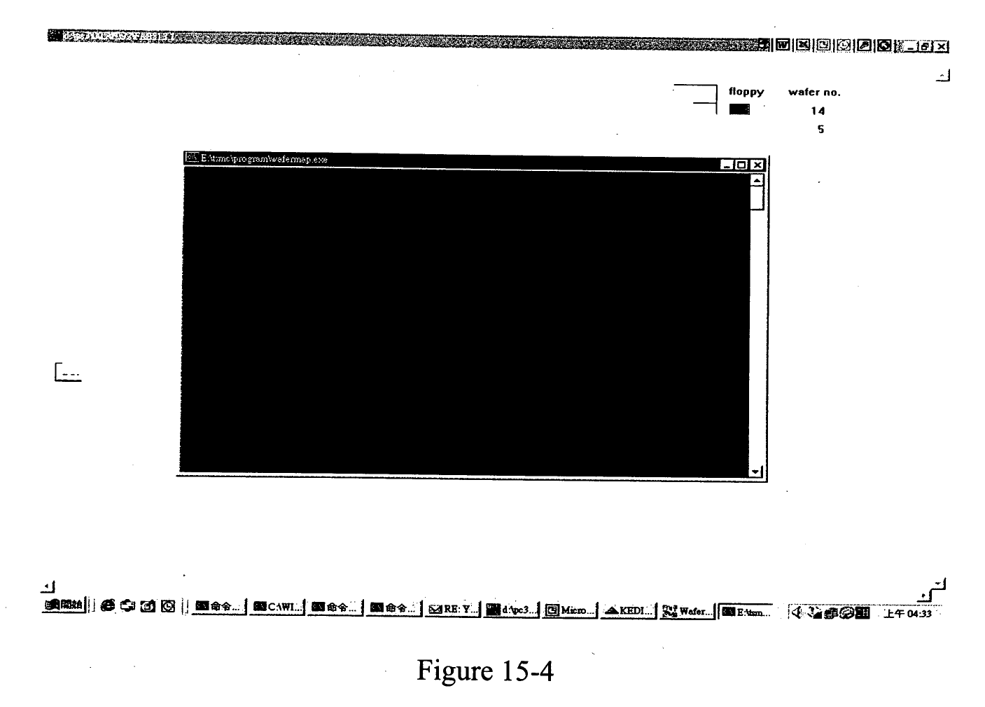

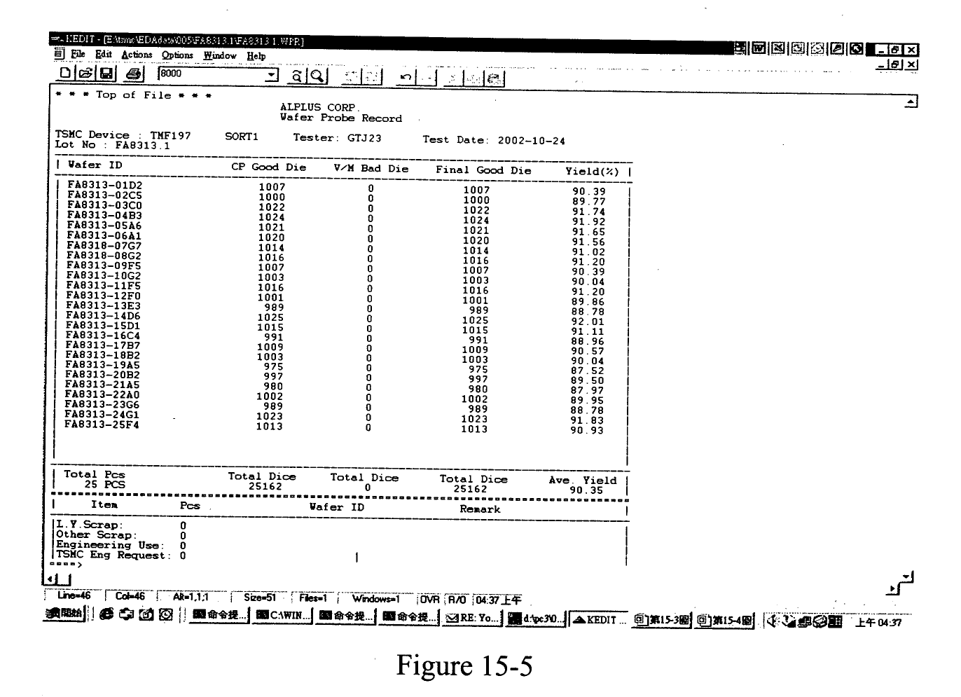

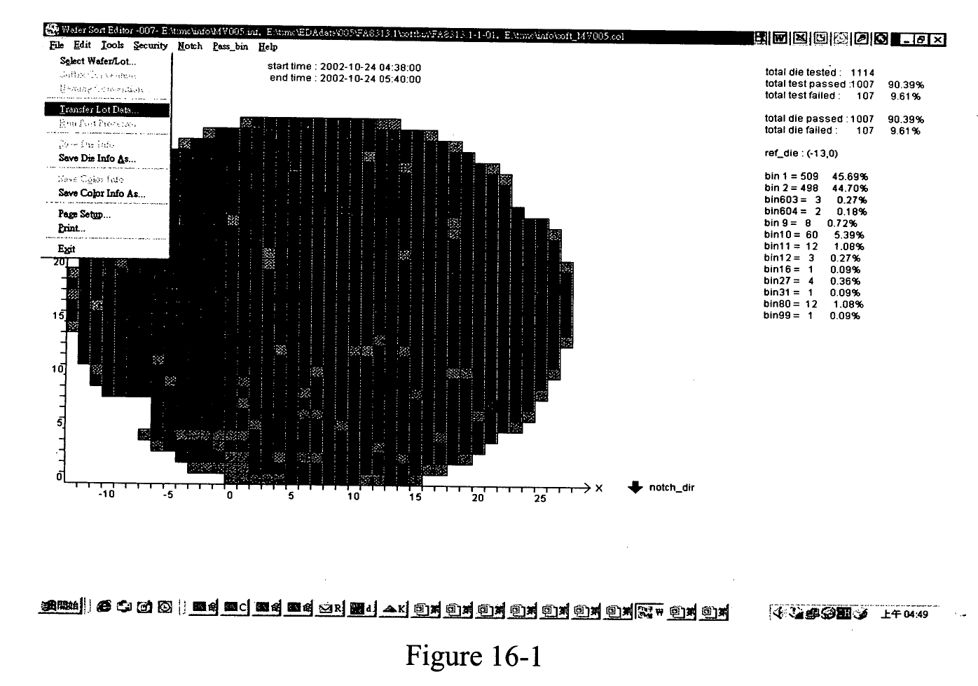

FIG. 15 is the screen display after directly entering the “Transfer Lot Data” option from the Action pull down menu in autoprocess.exe during wafer editing without using the editor program. FIG. 15-3 shows that all wafers can be selected to be transferred. FIG. 15-4 shows that the wafer data file is transferring to the ftp station. FIG. 15-5 shows the summary of final transferred results.

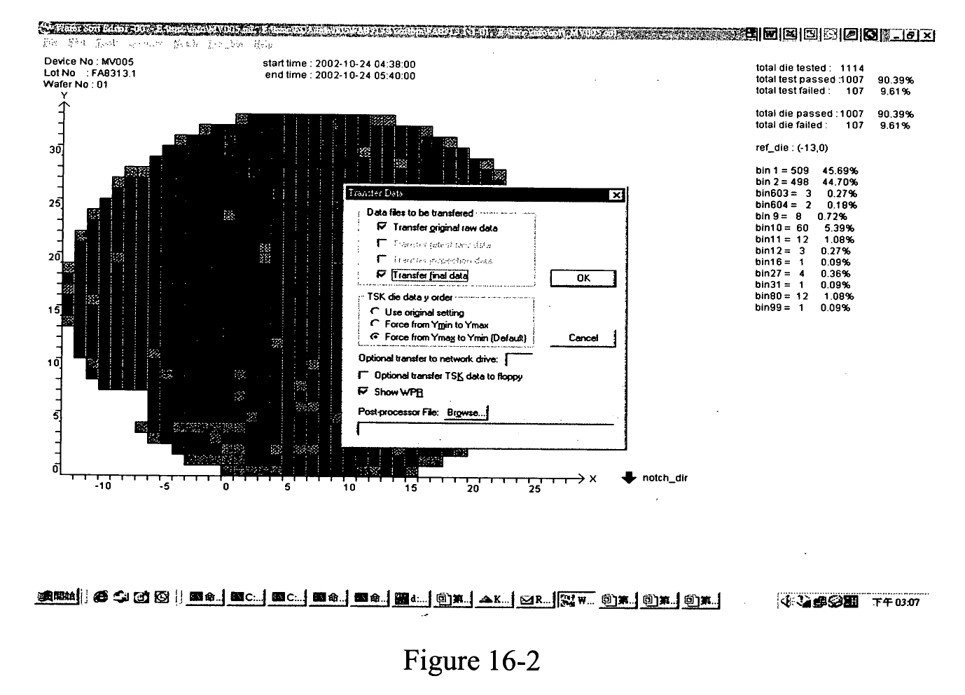

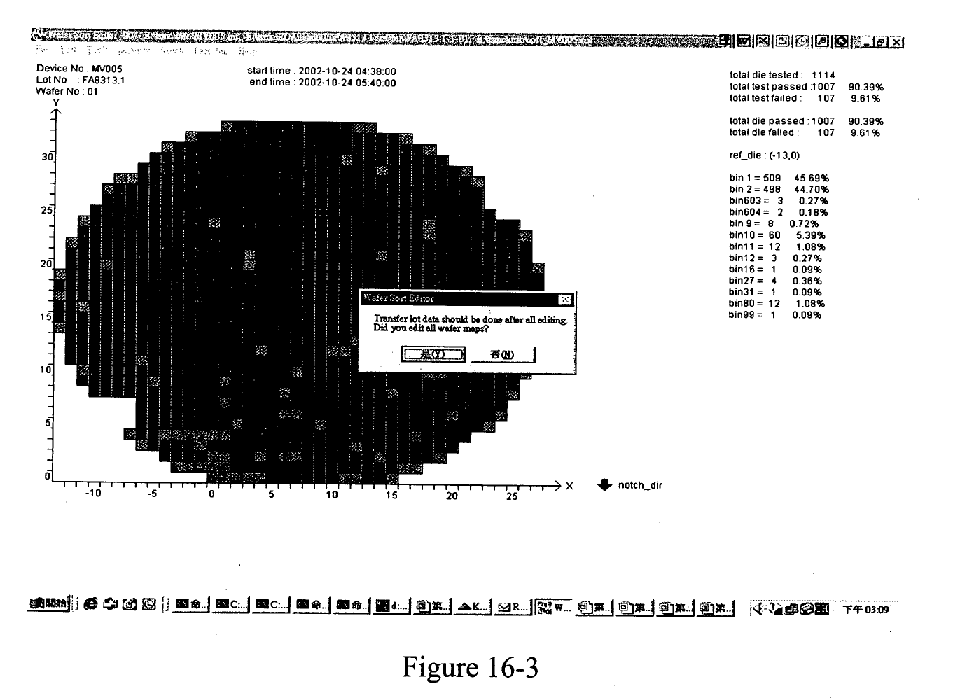

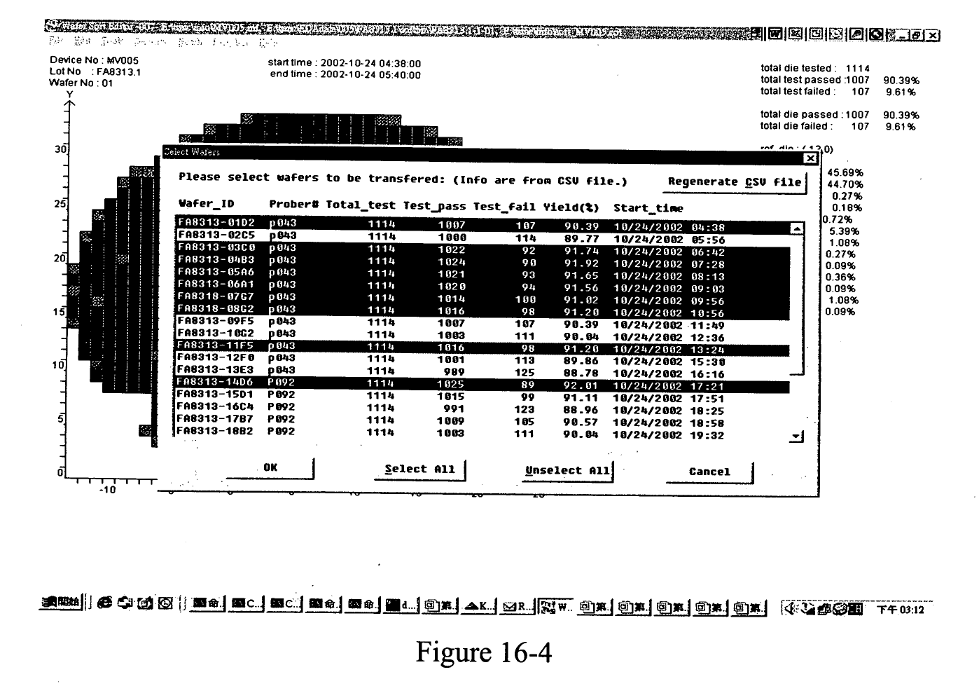

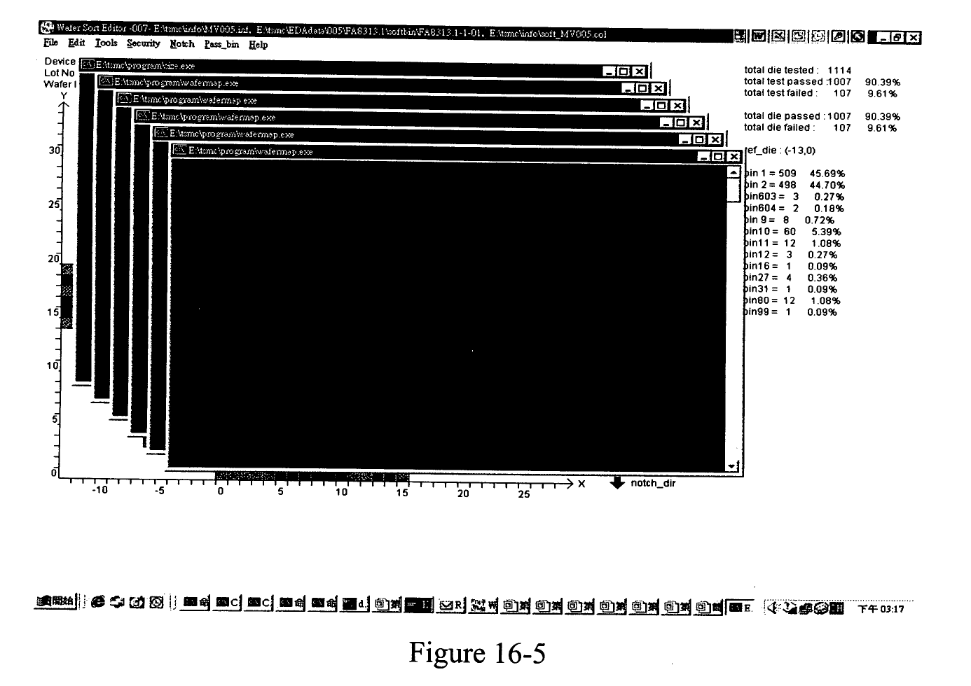

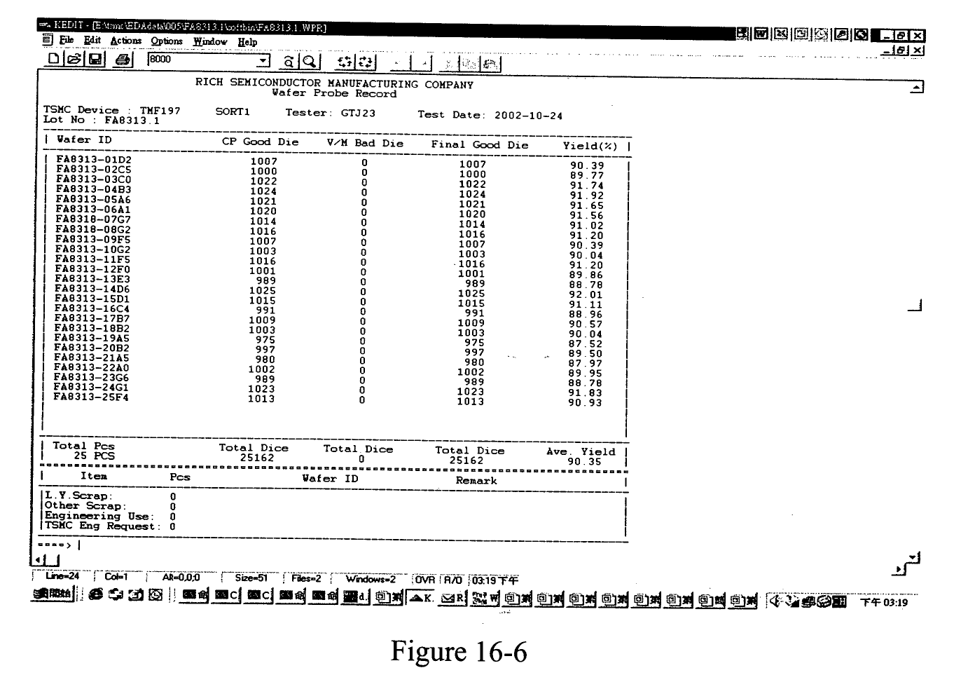

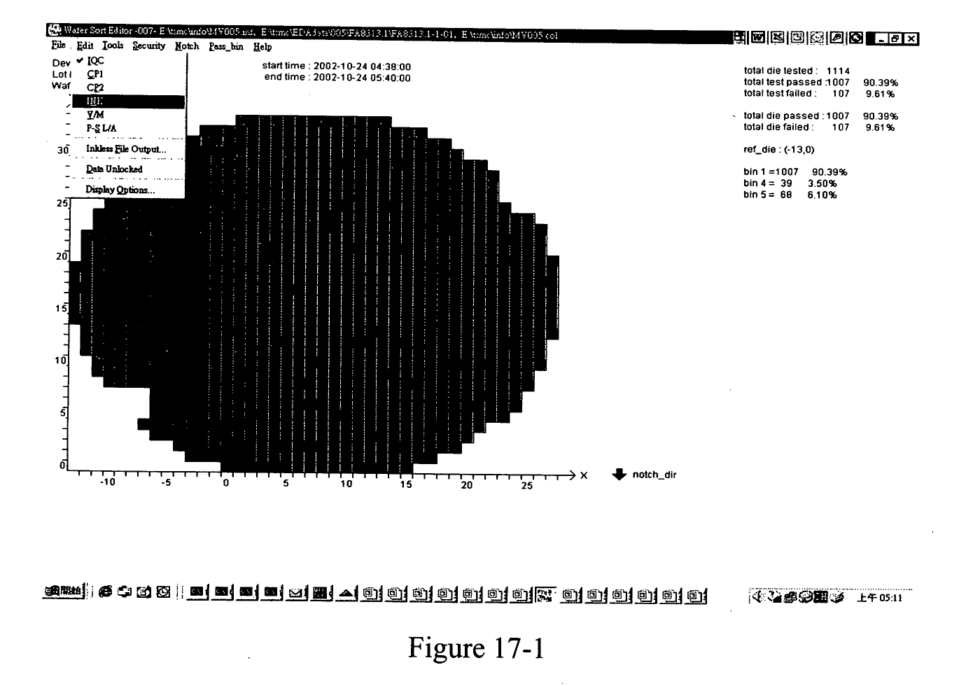

FIG. 16 is the screen display after entering the “Transfer Lot Data” option during wafer editing when the editor program is being used. The screens are very similar to that of FIG. 15. However, while the editor program is running, a user can edit the wafer map and then do the data file transfer.

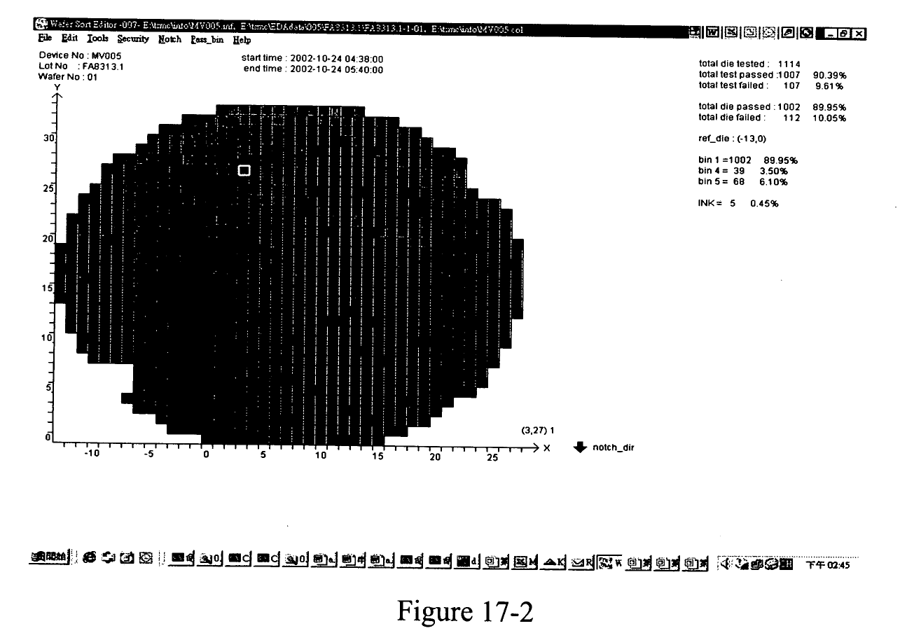

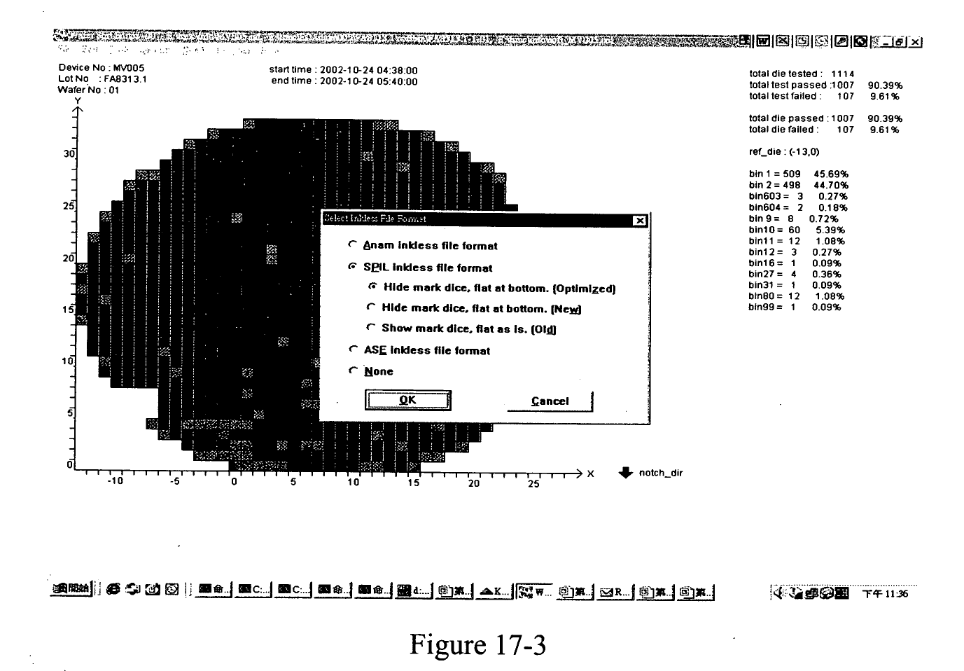

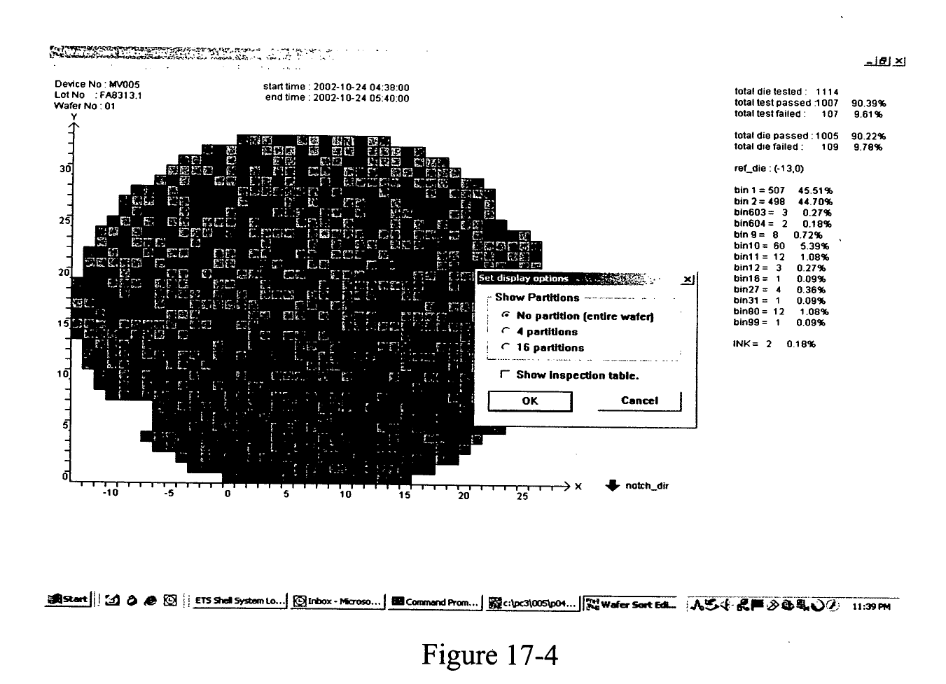

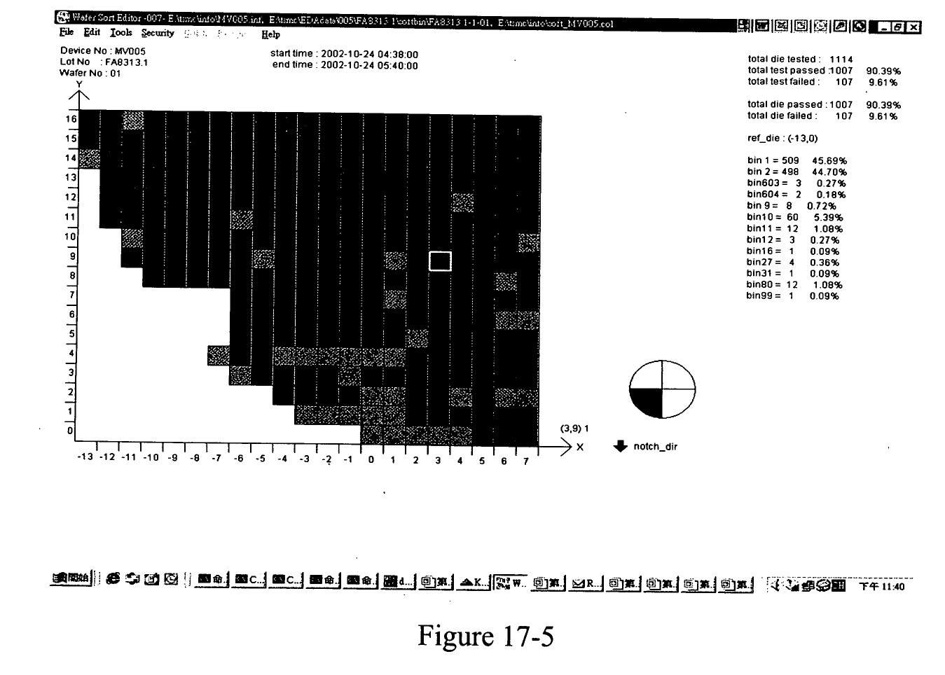

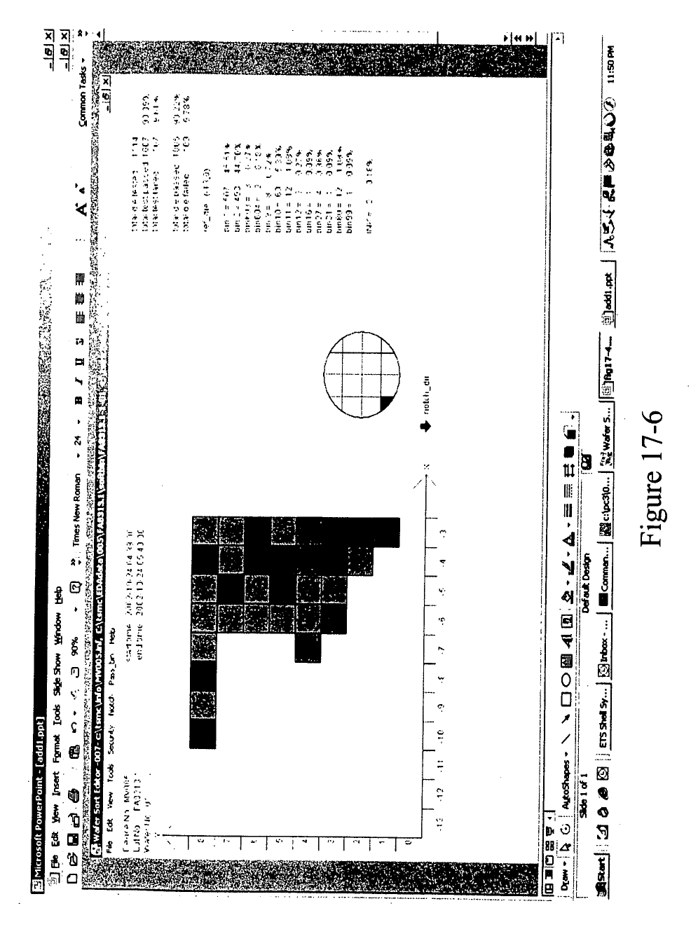

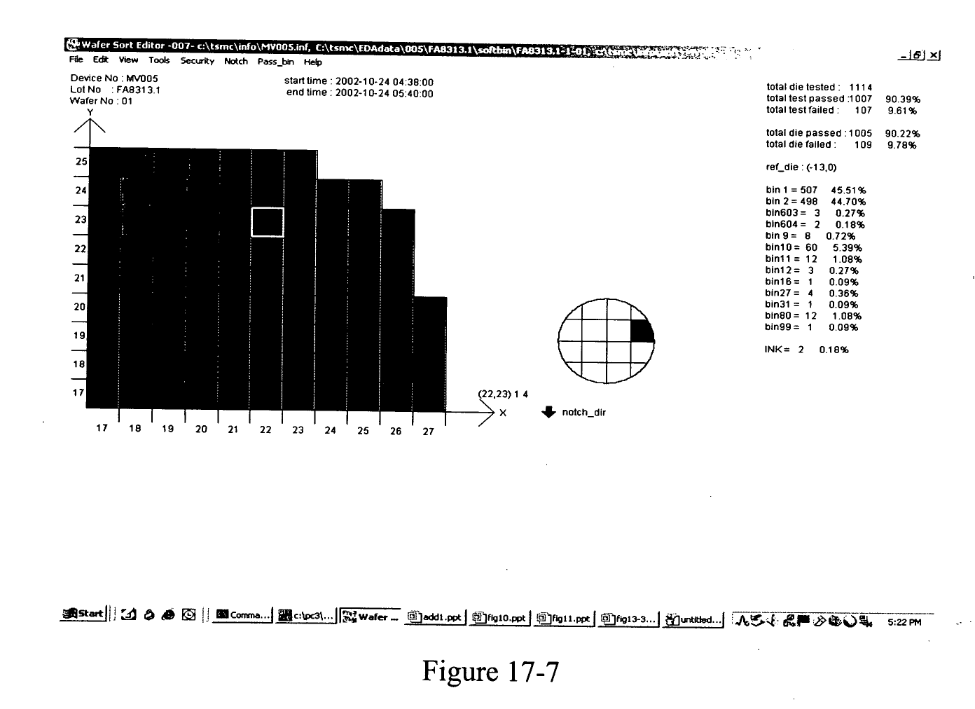

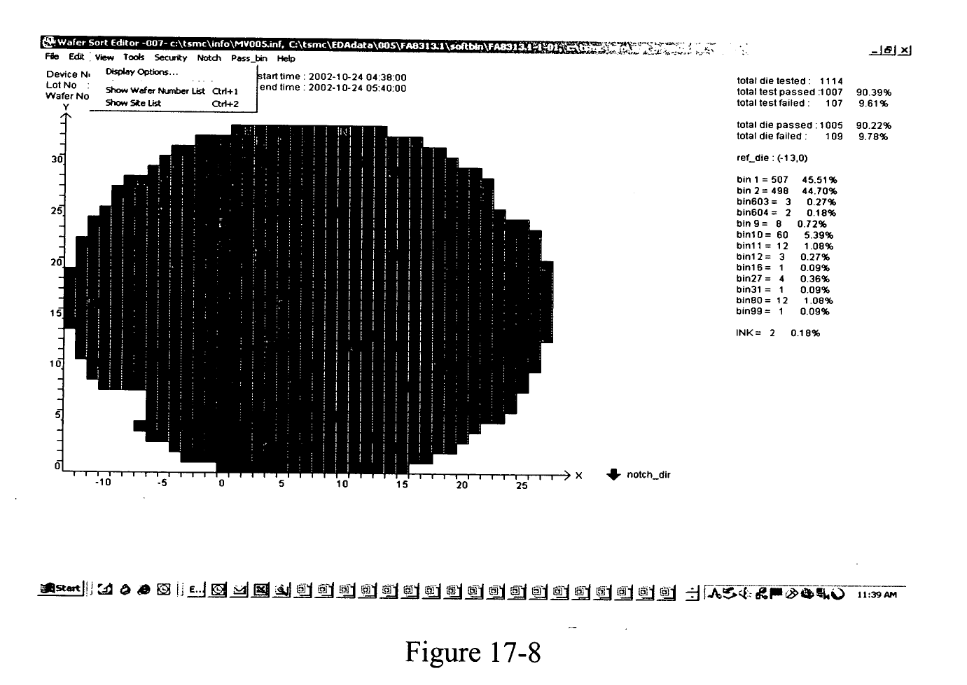

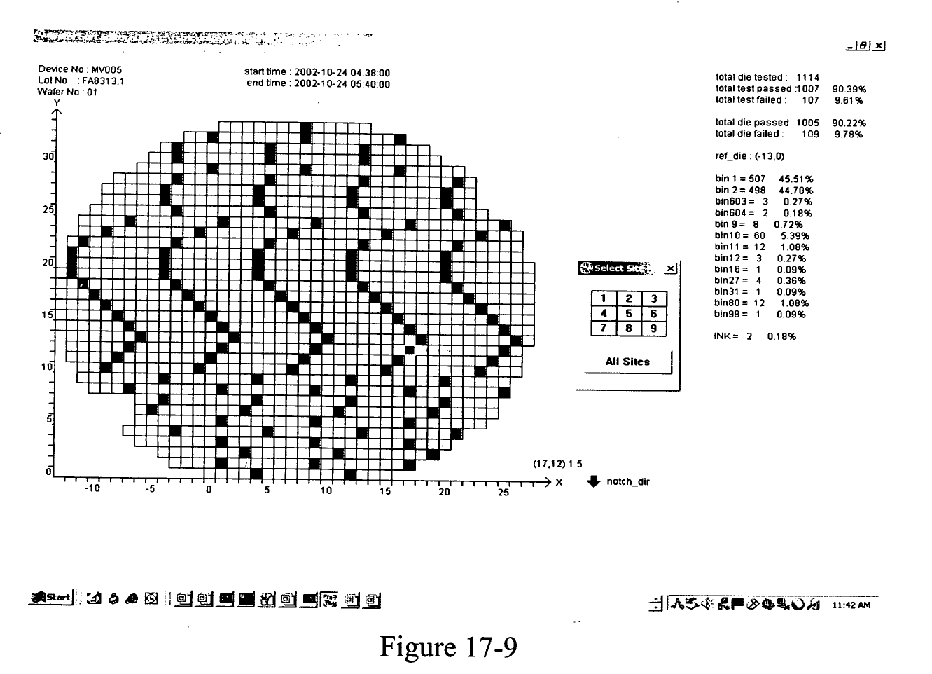

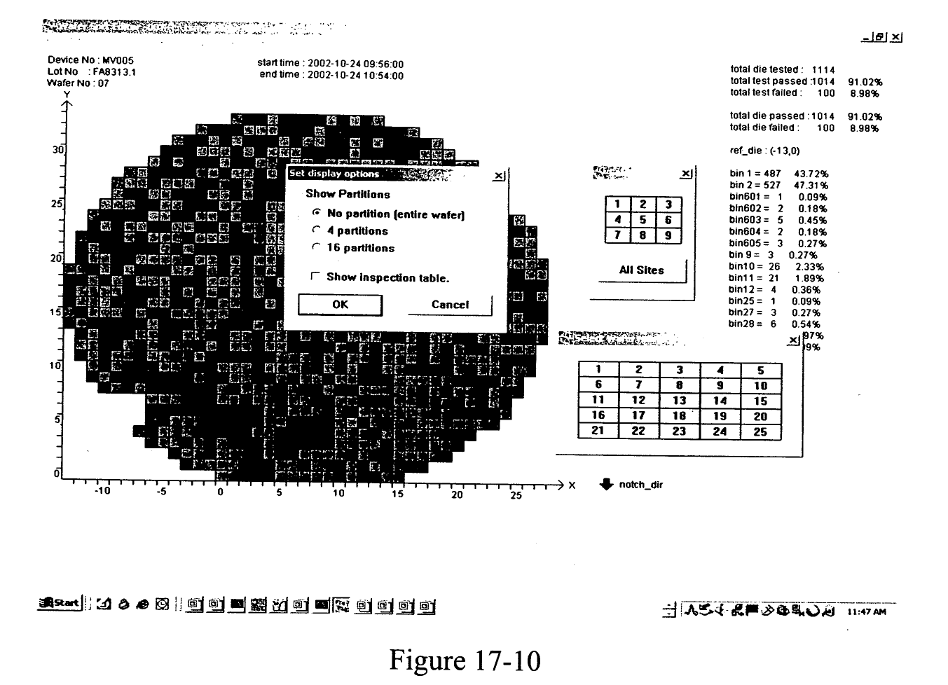

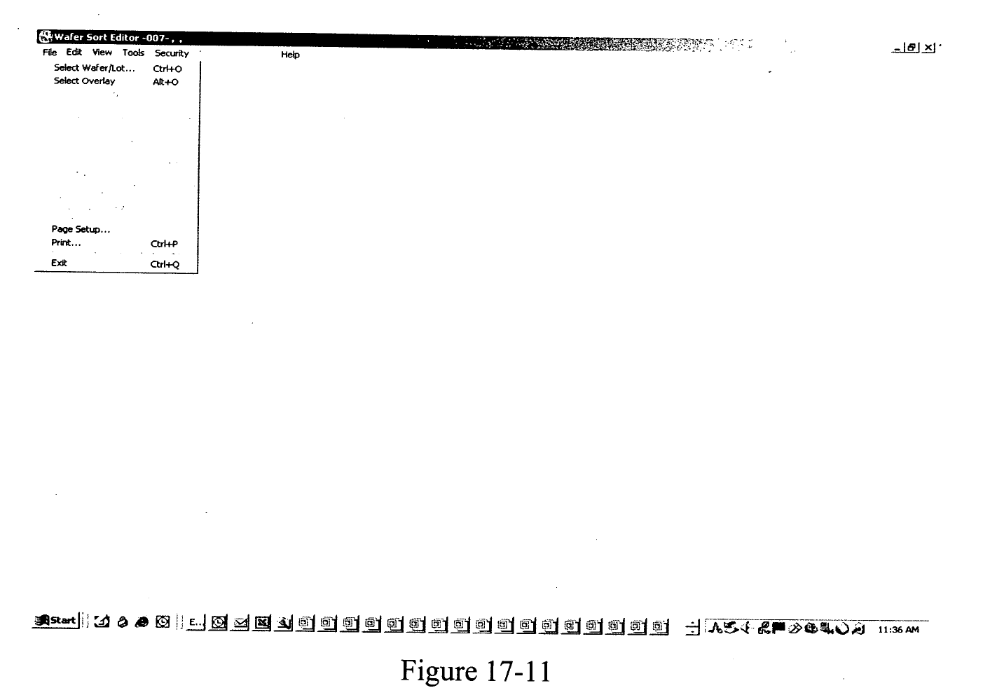

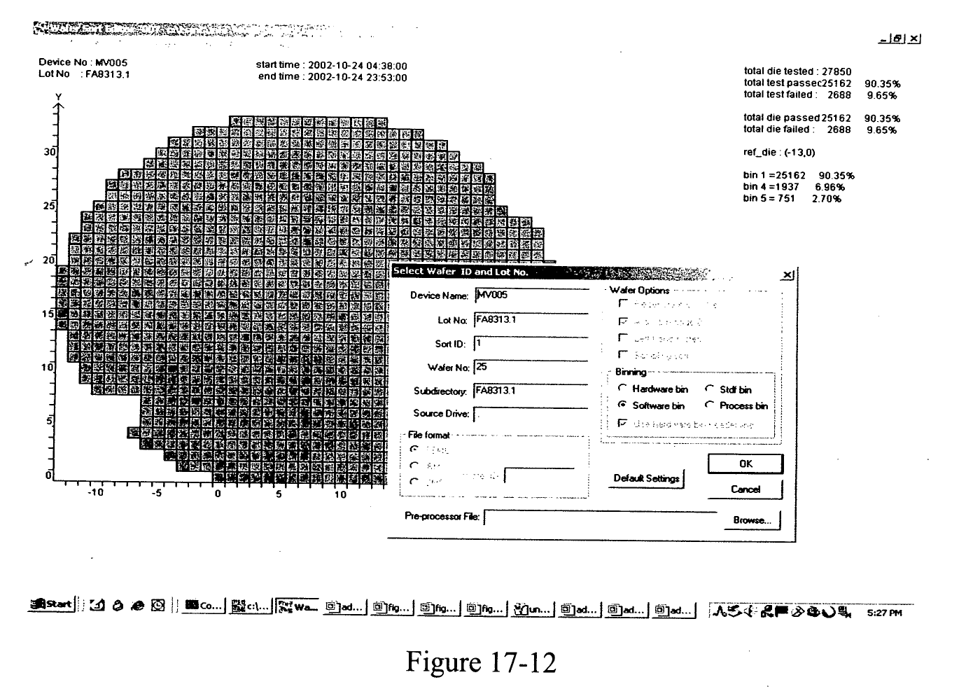

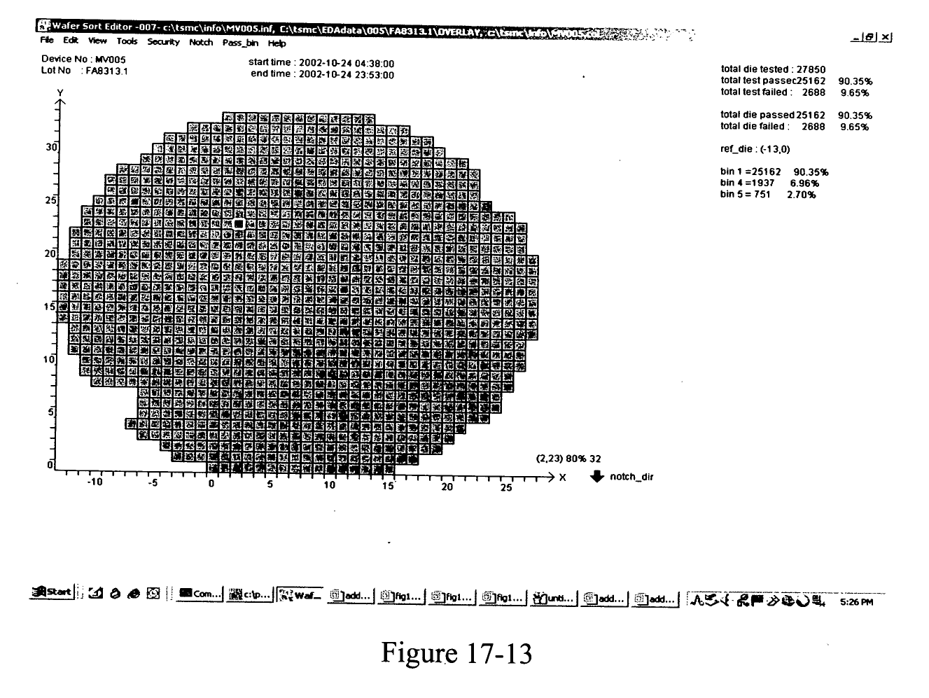

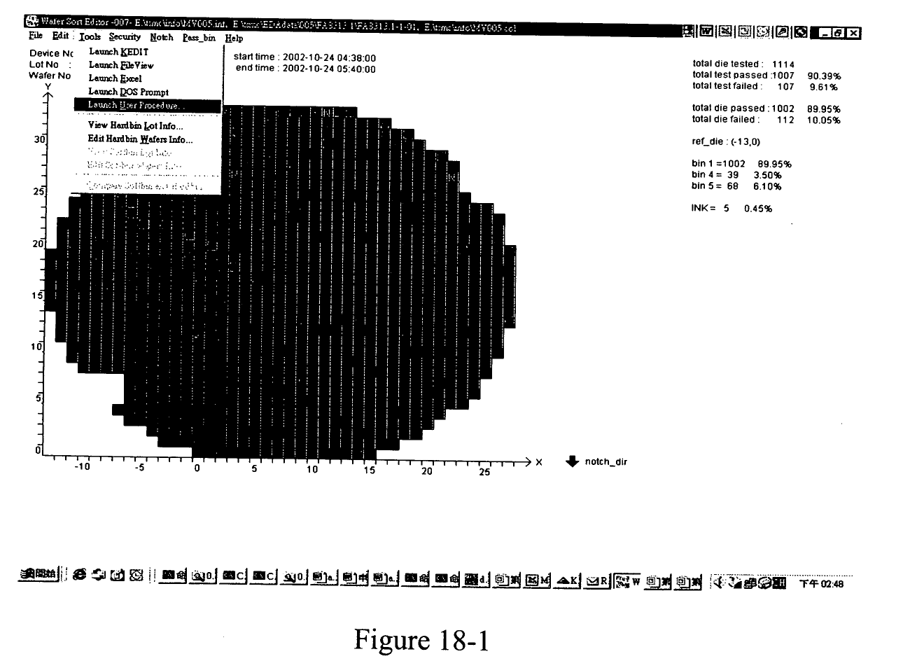

FIG. 17 shows a screen display of all options in different pull down menus of the “Edit” option when the editor program is being used. FIG. 17-1 shows that user can select the Edit menu and then the submenu for marking unwanted die under the 5 different stations (IQC, CP1, CP2, INK, V/M, P-SL/A) so that the user in different station such as INK (offline inking station) can mark out the die by selecting the INK sub menu and then moving the mouse cursor to that die and clicking it since some problem has been found on this particular die. A character “N” is marked on that die and then it will be saved as a bad die once the whole wafer data file is saved as shown in FIG. 17-2. This marking will show up if a user wants to open this wafer map file again.

By choosing “Inkless File Output”, a window will be displayed as in FIG. 17-3. Users can choose 3 major inkless wafer map file formats for 3 major assembly houses (Ankor Anam, SPIL, and ASE). Then users can select wafers to be transferred and inkless files will be generated and transferred to the ftp station as shown in FIG. 1.

Users can also select “Display Options” and then a small window will be displayed as in FIG. 17-4. Due to the large number of die on 12 inch wafers and efficiency consideration of locating the die, 4 partitions or 16 partitions button selection can be selected. As shown in FIG. 17-5, when the 4 partitions option is selected and the mouse is moved to the 3^{rd} quadrant and clicked, only 3^{rd} quadrant die will be displayed and the X, Y coordinates are also auto scaled to that quadrant. Users can move the mouse to a particular die and click it to select that die in order to mark it out.

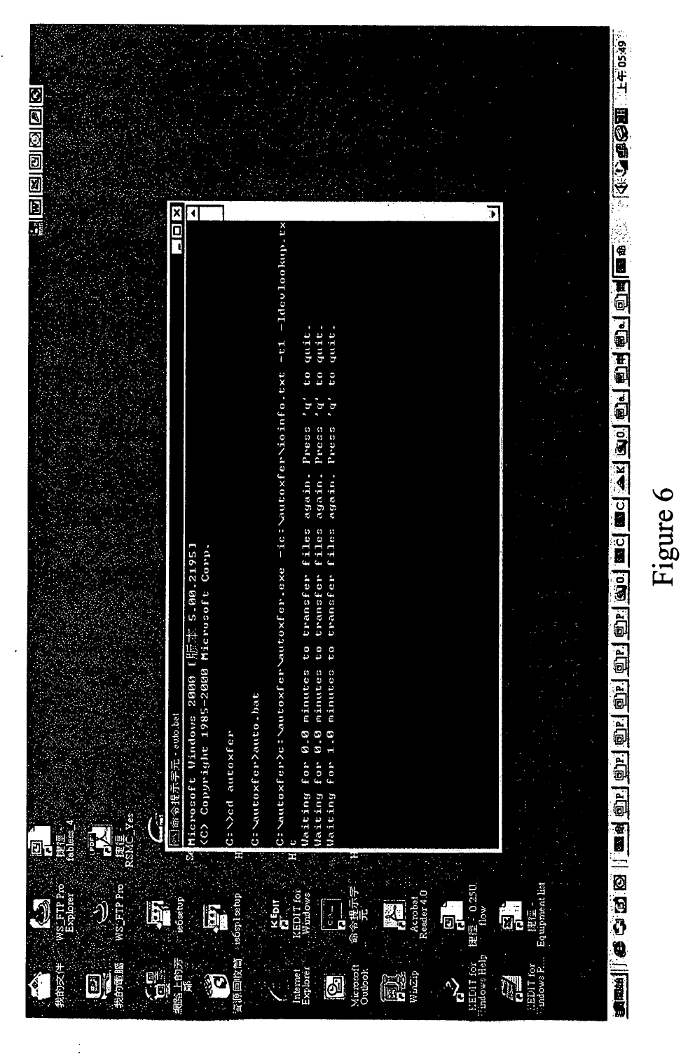

FIG. 17-6 shows that the 16 partitions option is selected and one of the 16 partitions is selected later. FIG. 17-7 shows that another one of the 16 partitions is selected and the number shown X, Y coordinated in brackets and that die is bin1 on site 4. FIG. 17-8 shows the “Show Wafer Number List” and “Show Site List” in the “View” menu.

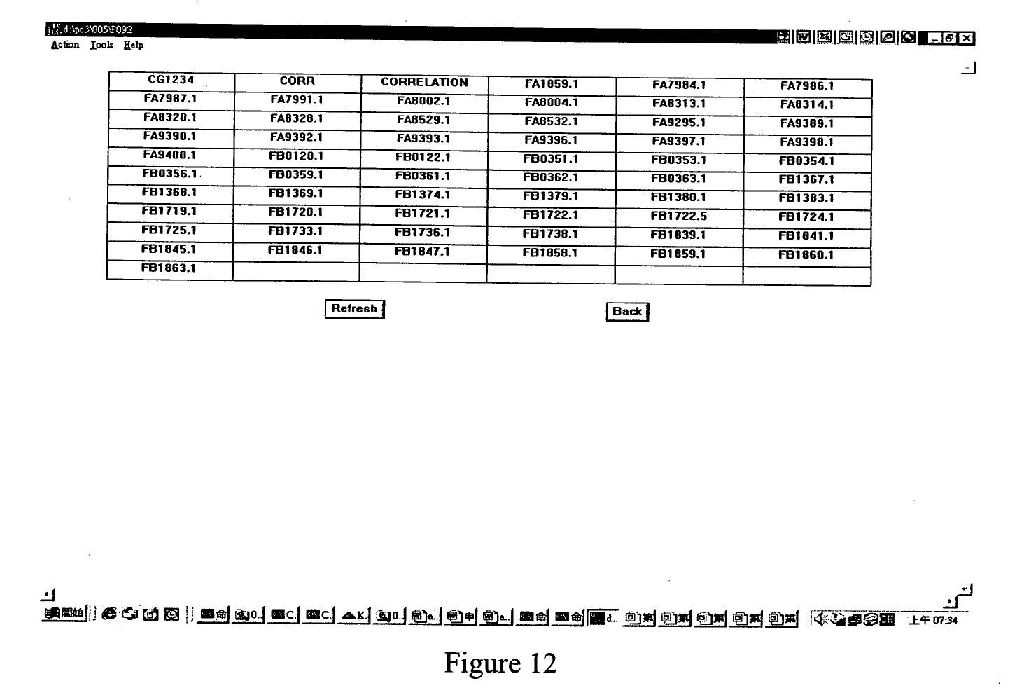

FIG. 17-10 shows that both of the above selections are checked and 2 small windows are displayed and can be further selected based on different site and different wafer by clicking the mouse cursor on that site number or wafer number.

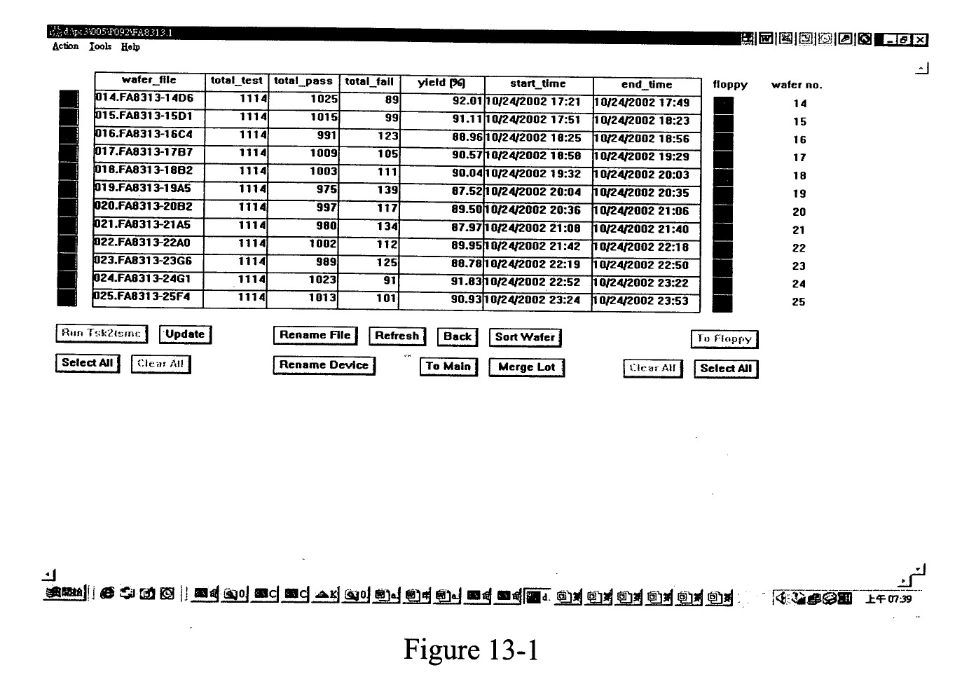

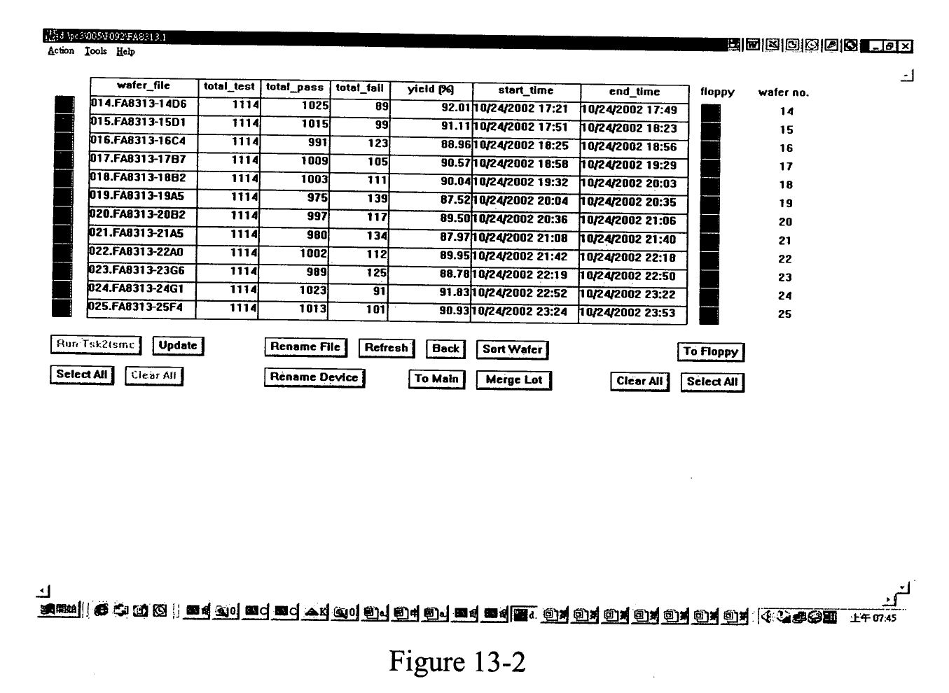

FIG. 17-9 gives an example of wafer number 1 and site number 5 being selected and only the die on site 5 will be displayed. FIG. 17-11 shows the “select overlay” selection item can be selected and FIG. 17-12 sub window will be shown and users can choose one of the 4 different wafer maps based on 4 different binning methods. These binning methods are 1. hardware bin, (from prober) 2. software bin, (from test program) 3. stdf bin, (from standard format data files) 4. process bin, (from E test or wafer process data testers). Each wafer soft binning files are under the same device and lot directory but different binning subdirectory. All these binning maps can be compared side by side to tell what reason caused the low yield wafer lot and give hints on how to improve the yield by tuning the related process parameters.

FIG. 17-13 displays each die locations yield report by overlaying whole lot of wafers on that particular die. For example, on location x=2, y=23, yield is 80% for all wafers on that die and this die is site 32.

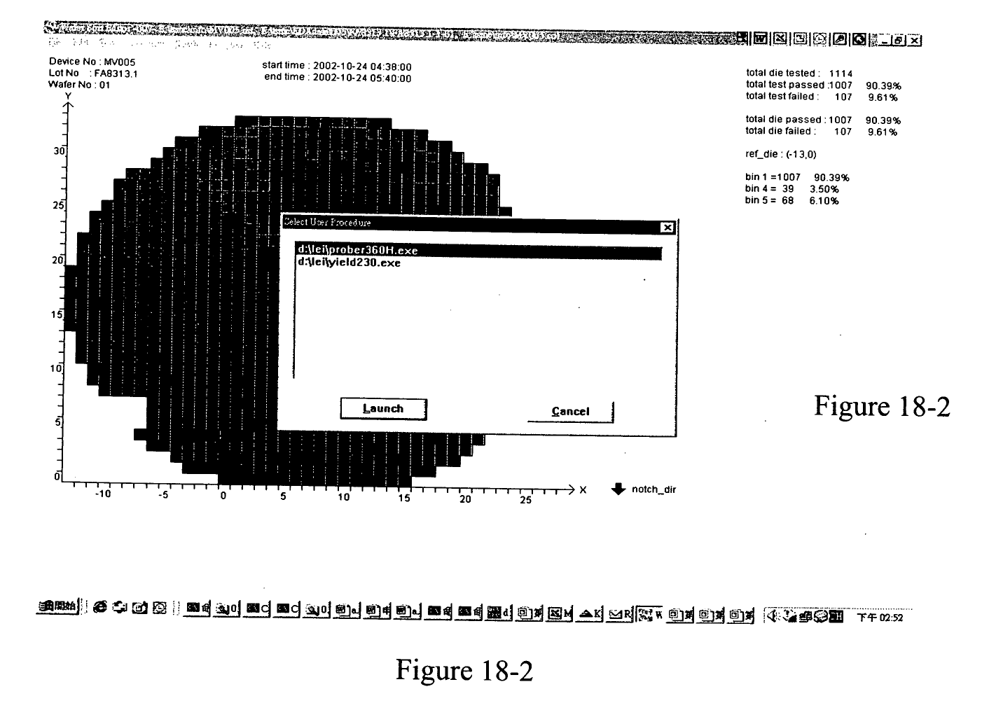

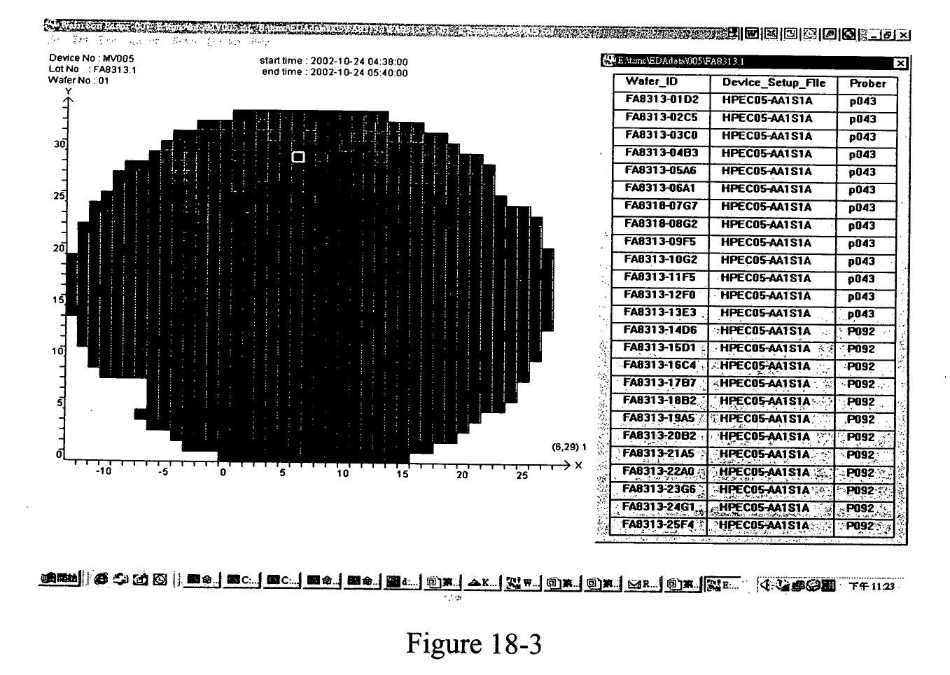

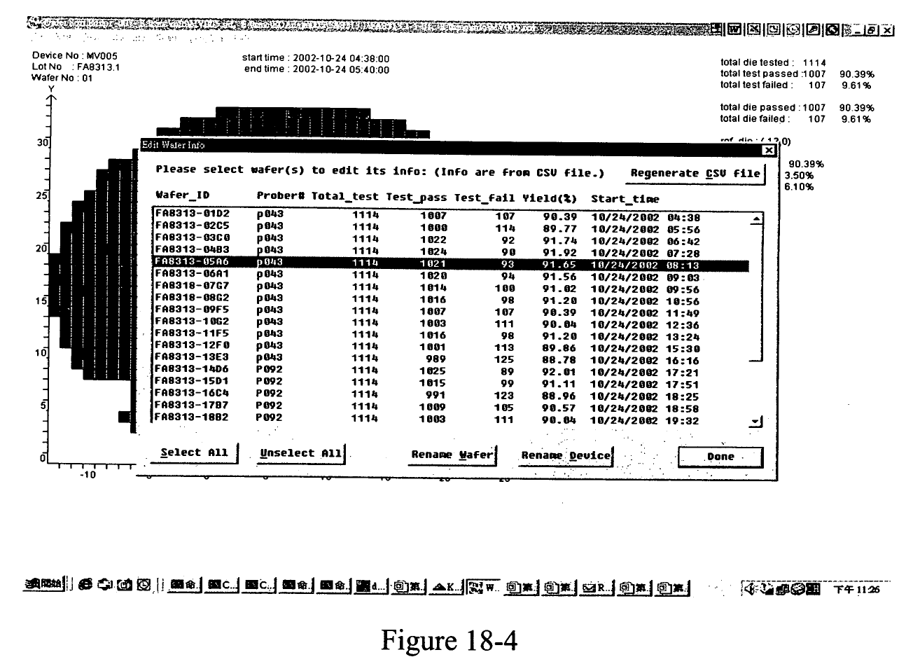

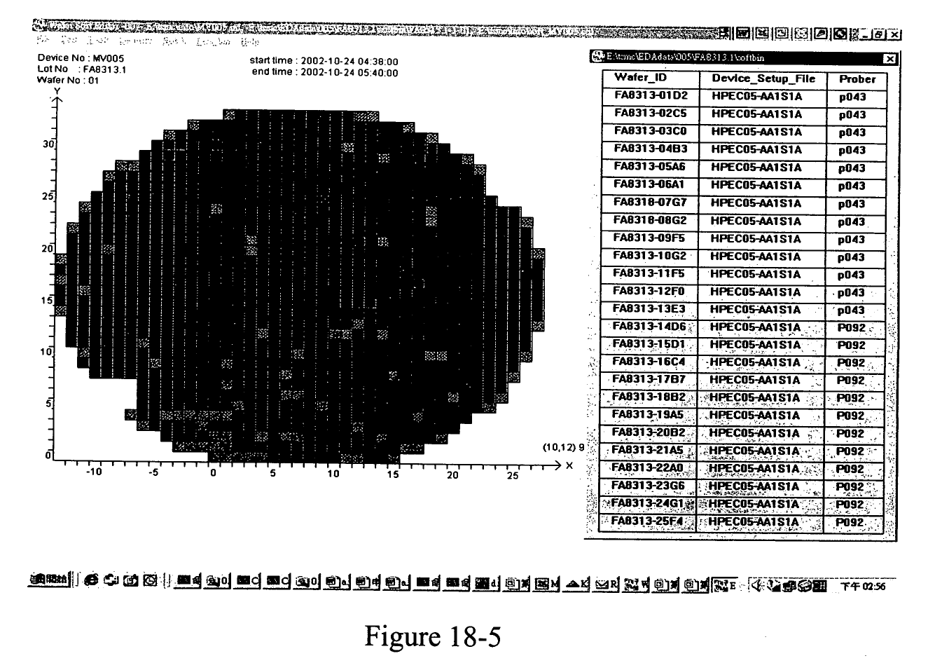

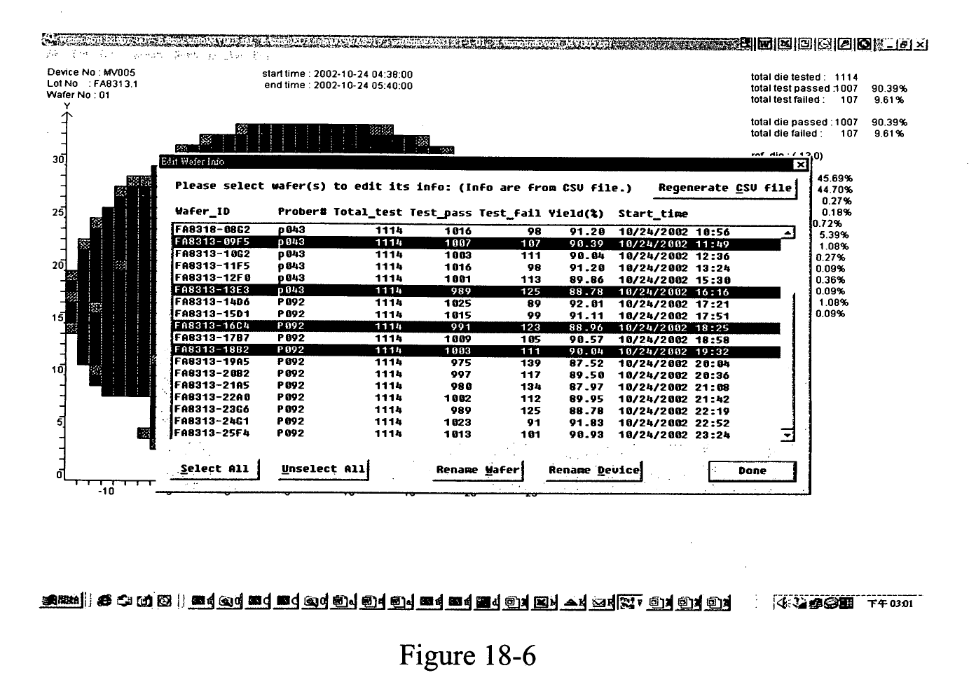

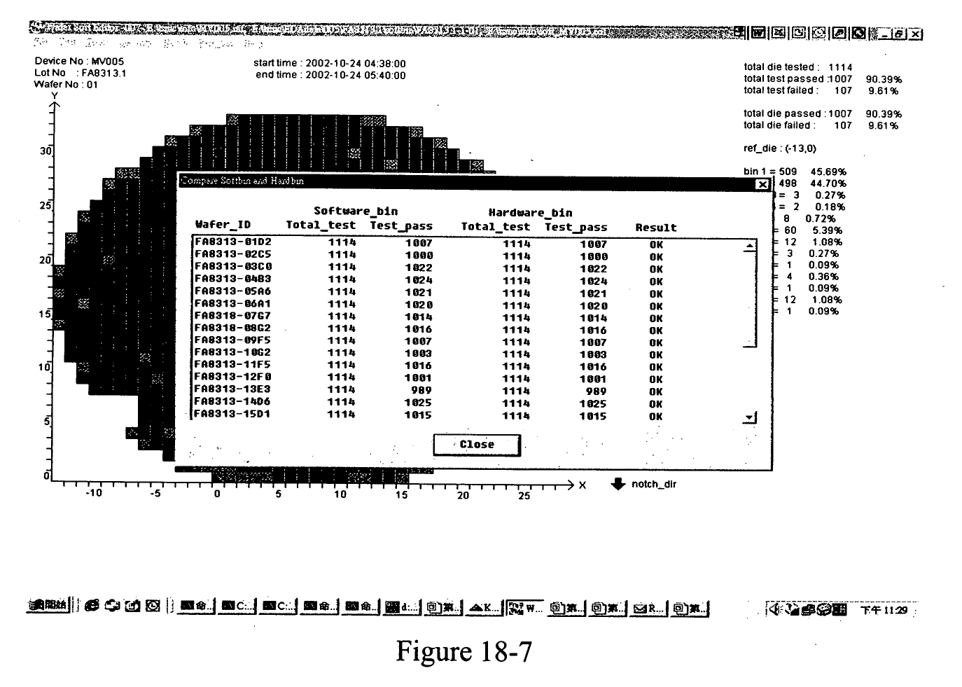

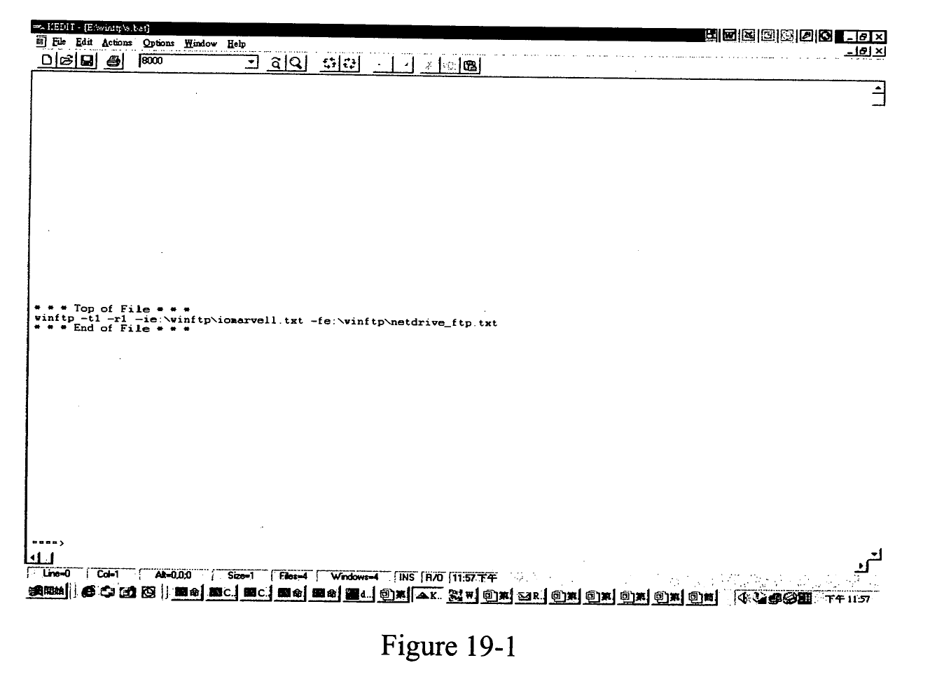

FIG. 18-1 shows a screen display of all options in different pull down menus of the “Tools” option when the editor program is being used. FIG. 18-2 shows the window once “Launch User Procedure” is selected. Moving the mouse over the user procedure program and clicking it, the program will be executed. These user procedures are defined inside the user procedure information file. According to different requirement, users can do data analysis while running the editor and accessing the database. This procedure could be a yield report bar chart in a specified time frame and specified prober and device.

FIG. 18-3 shows the window when “Edit Hardbin Wafers Information” is selected. It shows all wafer ID device setup file names and prober names. FIG. 18-4 shows the window when “View Hardware bin Lot Information” is selected. Users can move the mouse to single select or multiple select several wafers with corrected wafer yield and then transfer these wafer files to the ftp station.

FIG. 18-5 and 18-6 show the windows when “Edit software bin wafers information” and “View Software bin lot Information” are selected separately. Either hardware or software related selections can be selected. They can not be selected at the same time unless the user has gone up one level to switch the selection in 4 of selections “Hardware bin”, “Software bin”, “Stdf bin”, “Process bin”. For “stdf bin” and “Process bin”, selections can be added to the program in order to edit wafer information and lot information. FIG. 18-7 shows the hardware bin and software bin-comparing result once “Compare Software and Hardware bin” is selected. The result shows the same pass die count and gives the check mark “OK”. Otherwise, the check mark will be “FAIL”. If it is fail, this data file is not sent out.

This invention has many foolproof mechanisms. Some information files, like the map.inf, are generated by the tsk2tsmc.exe program and transferred to the lot directory. If an operator uses a wrong set-up file in a prober which results in errors in the map.info file, the supervisor can create a correct map.inf file in the parent device directory. The editor program gives precedence to the map.inf file in the parent directory. Certain information files, like the softmap.inf file, are created for testers or other machines. All such files are stored in device directories.

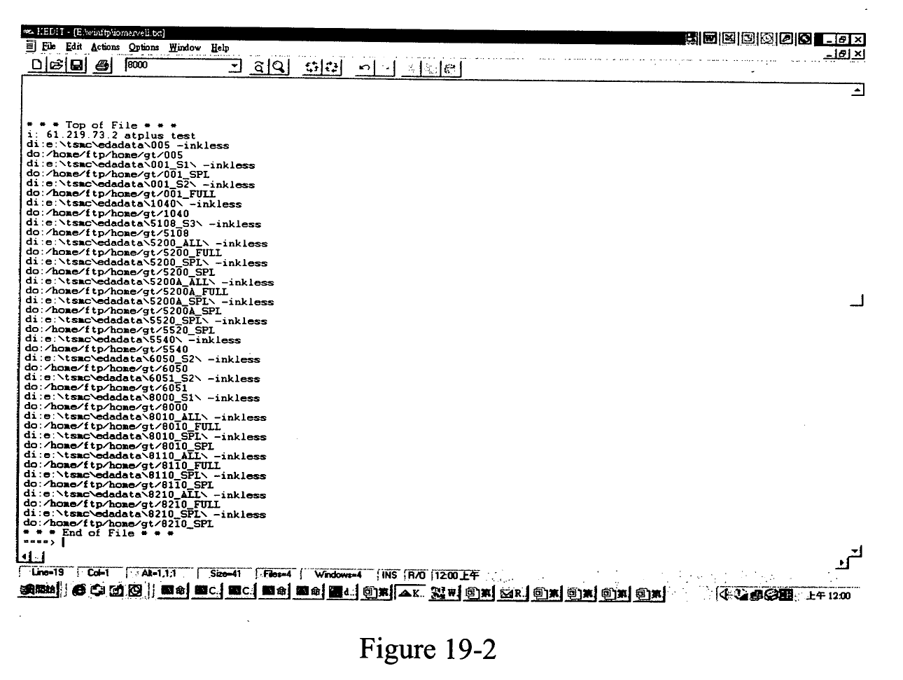

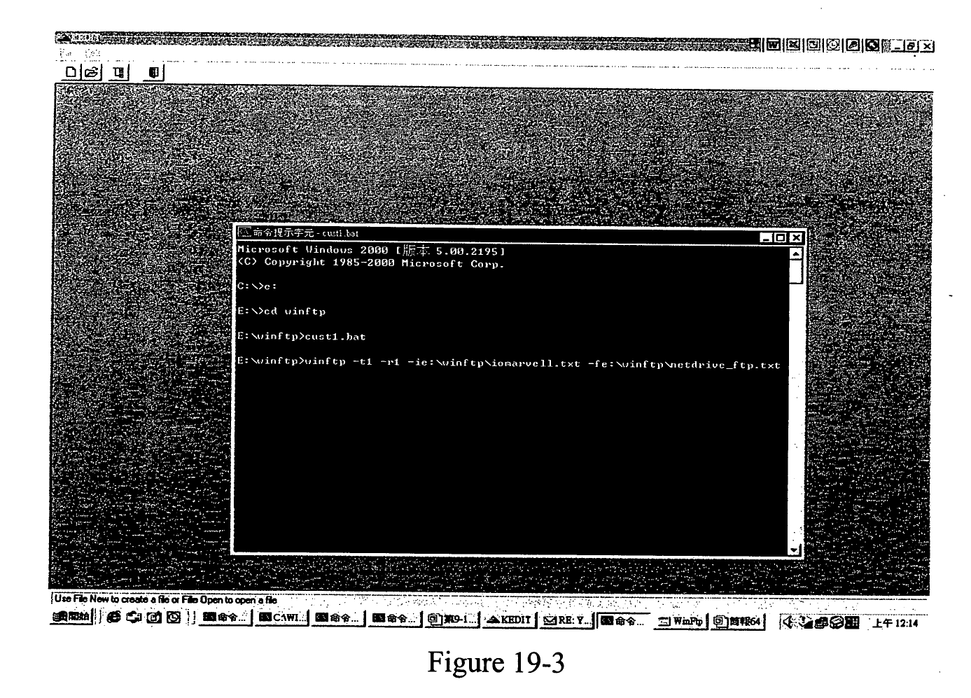

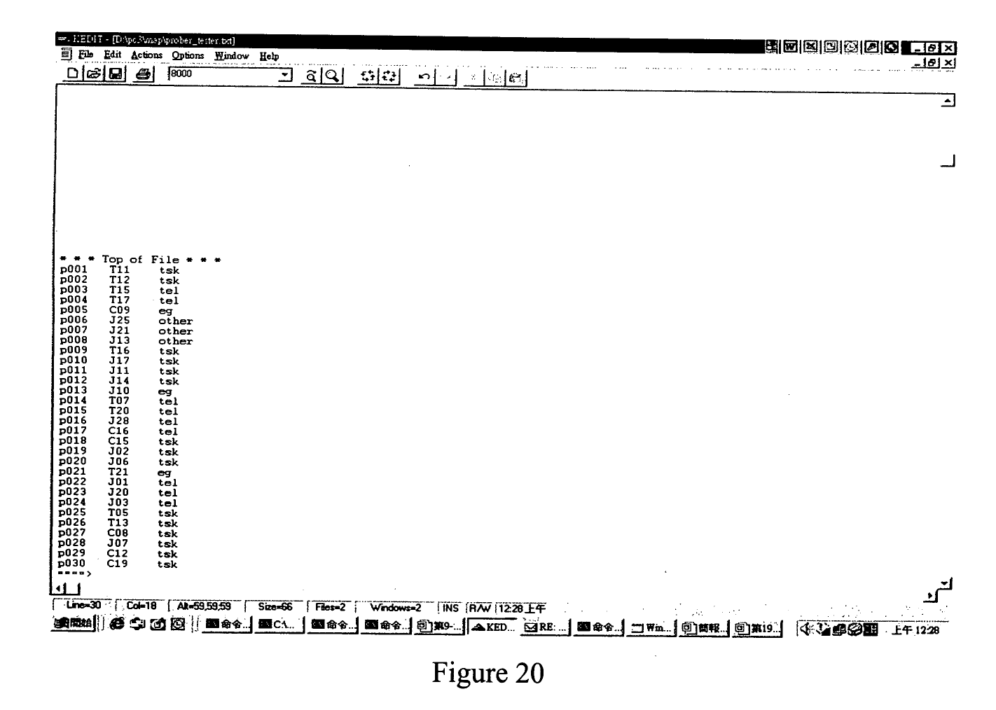

FIG. 19-1 shows the corresponding batch file when the winftp program is in use.

FIG. 19-2 shows the input output information file (iomarvell.txt) when the winftp program is in use. The first line shows the IP address, user name and password used by the ftp. The second line shows the path of the device that is scanned by the source terminal. All data in the inkless sub-directories of sub-directories under this path need to be transferred by ftp. This switch can be defined multiple times to send out different data. If no switch is defined, all files under all sub-directories of the lot of the device are sent out using ftp.

FIG. 19-3 shows the screen display during execution of the fourth program, which performs automatic external transfer. All file sent out are displayed on screen. If the program is not scanning, the screen shows the waiting state.

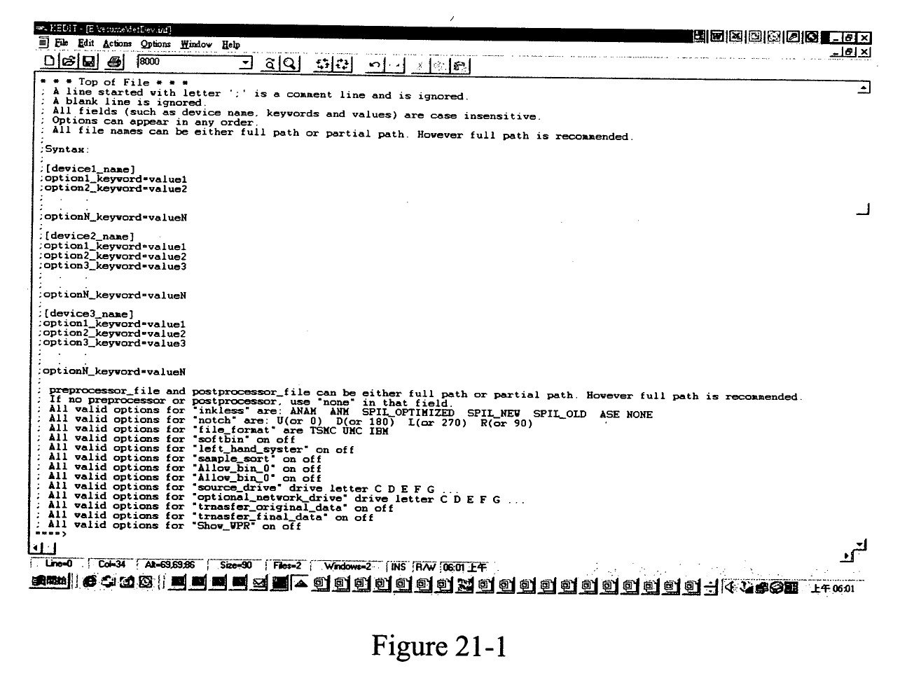

The look-up table in FIG. 20 explains the flexible design of this invention. This file prober_tester.txt is an information default file which autoprocess.exe must read.

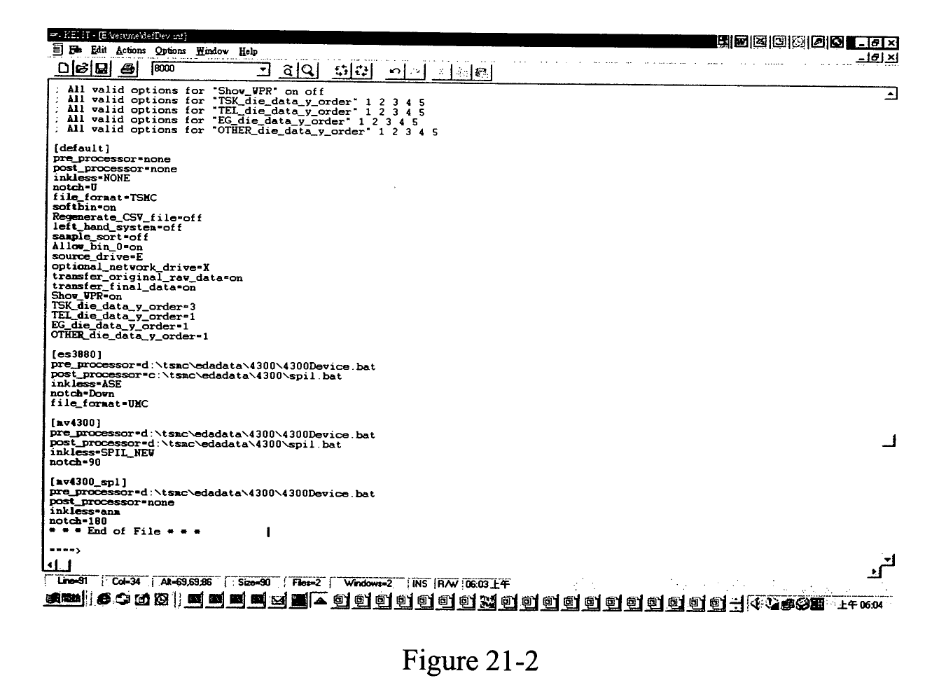

The look-up table in FIG. 21-1 and FIG. 21-2 explains the flexible foolproof design. The file defdev.info is an information file which autoprocess.exe and editor.exe must read but from different directories.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A real-time processing and monitoring software based on DOS, Windows, or Linux operating systems, comprising:
a plurality of small externally hooked programs capable of operating independently under the DOS environment;
a main program running under the Windows environment and to which the external programs are hooked and whose functions are designed to target needs in production line wafer testing and comprising universal and integrated functions, which constitutes a production line oriented data processing system with four basic functions, the functions comprising:
receiving and transmitting data;
processing data immediately and in real-time and displaying the data;
editing or comparing processed data or displaying error messages; and
transmitting to and archiving data on a manufacturing execution system;
whereby the basic functions are built upon four independently working programs, in which the four software sub-systems communicate with each other using a built-in special interface file set-up, which is a seamless communication infrastructure and which furnishes a production line with a primary data management system.

2. The real-time processing and monitoring software of claim 1, wherein four different wafer mapping or binning maps can be selected, the binning maps comprising hardware bin, software bin, stdf bin and process bin.

3. The real-time processing and monitoring software of claim 2, wherein dynamic binning change is accomplished by extracting a data log file from an stdf file, changing test limits based on statistical process control analysis, and recreating a binning file to rescue marginal dices using several hooked external programs and batch files.

4. The real-time processing and monitoring software of claim 2, wherein based on different request from a user, test limits can be changed dynamically if the user uses stdf bin files and external programs so that yield can be modified by the user on their own site or from a remote site through windowed terminal service and data log data can be extracted from the stdf file and a binning result is recalculated based on statistical analysis.

5. The real-time processing and monitoring software of claim 1, wherein system architecture suitable for operation of any production lines with massive data processing comprises hooking external programs to a main program with an open architecture in order to satisfy different requirements including but not limited to communication between WIP systems and MES systems and comprises a plurality of binary to ASCII and ASCII to binary file conversion formats.

6. The real-time processing and monitoring software of claim 1, further comprising open architecture software which is based on fixed sub-directories and uses common ASCII files as databases; and when the user interface is in use, the mouse displays selection results based on the hierarchical relationship of sub-directories.

7. The real-time processing and monitoring software of claim 1, further comprising software which, according to one or more user specified information files, receives and transfers data within a production line; the software logs are transferred regardless of success or failure; the software moves successfully transferred data to specified back-up directories and moves data not successfully transferred to directories named after failed network drives to facilitate retransfer a next time the failed file is scanned automatically.

8. The real-time processing and monitoring software of claim 1, further comprising software which determines methods to handle devices based on existence of binning information files under the program, which also determines which type of prober and tester are used or code names of prober directories using one of more files, which defines set-up and requirements for all different probers and all different devices in one or more separate look-up information files, which defines any network drives to which any output files are sent in one or more files, which stores all relevant information in files, which executes simultaneously on one or more working platforms, which performs mutual data back-up data on multiple platforms via its network drive function, and which uses network-mapped drive functions to execute programs on one or more on-line monitors externally connected to each working platform to perform on-line monitoring of data in the working platform.

9. The real-time processing and monitoring software of claim 8, further comprising in addition to the common method of a menu bar, a processing menu item selection method which displays sub-menus within a menu by computing screen area occupied by each sub-menus and selecting an item by moving a mouse pointer to a location on screen corresponding to an item, which speeds up selection by using “page up” and “page down” buttons when the screen cannot display all selections and which uses selection buttons with different functions at the bottom of the screen to achieve easy selection and operation.

10. The real-time processing and monitoring software of claim 9, further comprising a yield chart of all wafers corresponding to a device, prober and lot combination, all corresponding wafer have a small square for selection, which can be used together with the selection button for function selection, the function saves selected data onto floppy diskettes which can be placed into a prober for re-test for rejects; a green color in a square indicates that data is in a working directory, a white color indicates a backup directory file, and squares are used with the select button.

11. The real-time processing and monitoring software of claim 9, further comprising a menu bar function by which types of external tools can be invoked, by which externally added software can be invoked, also by which user procedures contained in files can be invoked and which allows user procedures to be modified by modifying files containing such procedures.

12. The real-time processing and monitoring software of claim 9, further comprising a method by which a wafer map editor is invoked, which links two software functions and which writes information about any subdirectories belonging to a specific wafer and lot combination to a file for the wafer editor when the wafer editor software is invoked.

13. The real-time processing and monitoring software of claim 1, further comprising, a mechanism by which selection menus are specified and defined in the software, in which menu definitions, including but not limited to names of pre-processor, post-processor, software bin, hardware bin, inkless format, input file header line definition files, name of output file header file definition are specified in one or more information files read when the editor starts, in which the selection menu defined by the mechanism can be locked during execution of the wafer editor to make it foolproof, in which the locking of the selection menu definition can be optionally changed by disabling the locking function of information files.

14. The real-time processing and monitoring software of claim 1, further comprising, software which displays wafers with its own routines instead of routines from Windows and by doing so effectively controls screen locations corresponding to each die on a wafer, which selects a die by moving a mouse pointer directly above a die on screen, and which displays the wafer coordinates, binning number and site number of a die and out-line of the die on the wafer map when the mouse pointer is over a die on the wafer map.

15. The real-time processing and monitoring software of claim 1, wherein while processing wafers, which may be eight or twelve inches in size, with a large number of dies, a mechanism of either four partitions or sixteen partitions can be selected by which partition on a wafer is displayed and selected, which upon being turned on immediately shows the four or sixteen partitions on the screen and which selects a partition for further die selection when the mouse pointer is clicked over the quadrant.

16. The real-time processing and monitoring software of claim 1, wherein when calling the third function software it is also possible to chose the “Transfer Lot Data” option and completely skip the third function software; after verifying data, the user interface appearing at this time can go to another screen which performs selective or whole wafer data transfer to a station running the fourth function software; this way entering the wafer editor can be avoided to increase efficiency.

17. The real-time processing and monitoring software of claim 1, wherein after entering the wafer map display, operators can use the arrow key to go from one wafer to another wafer and continue editing after editing the first wafer; when all editing is done and lot transfer is in progress, operators can exit all wafer screens and use control key and shift key for wafer batch processing; all data sent out for batch processing have a summary file for record; and for each generated summary file, the function software assigns a new extension number for future reference and verification.

18. The real-time processing and monitoring software of claim 1, further comprising:
using header line definitions in an information file to decide the format of a header line of an out-going file when a user transfers data to station running the fourth function software, at the same time it also executes the batch file specified in the post processor to generate customer requested files, all actions executed generate a yield summary file lot file, and the final action generates a lot final file, and depending on the order of batch data processing, an extension is added to distinguish different batches, the information record each time will be use later for query, which is done off-line and using text file query, to track all things which happened in the past; and
using externally hooked software in the postprocessor to generate an output trigger file and error trigger file to determine if data are sent to the station running the fourth function software, which is a final gatekeeper for out-going data and handles requirements for different customers and products, and whose function is defined in an information file and executed by externally hooked software in the postprocessor.

19. The real-time processing and monitoring software of claim 1, further comprising, creating information files for individual customers and executing corresponding batch files when transferring data to each customer, the information file containing individual customer information including IP address, user name, and password, local and remote directories of a device, and sub-directories that are under the lot sub directory and to be transferred are specified by a switch instruction, wherein if there is no switch specified then all data under a lot sub directory are to be transferred; the switch directive can have multiple selections that are processed simultaneously, and other characteristics of the software include automatic scanning; automatic backup and intelligent retransferring.

20. The real-time processing and monitoring software of claim 1, wherein all support software in the four function software sub-systems are DOS command line programs, therefore the working platform has a flexibility provided by command line programs and becomes a universal and integrated wafer testing real-time monitoring software with a seamlessly integrated overall structure.
